(19) United States
(12) Patent Application Publication
(10) Pub. No.: US 2026/0297753 A1
(43) Pub. Date: Oct. 1, 2026

(54) DEPOSITION OF CERAMIC MATERIALS TO POLYMER SUBSTRATES

(71) Applicant: Nelumbo Inc., Hayward, CA (US)

(72) Inventors: Lance R. Brockway, Hayward, CA (US); David C. Walther, Hayward, CA (US); Hyungsub Kim, Hayward, CA (US); Josh Rafshoon, Hayward, CA (US); Brian P. Sweeney, Hayward, CA (US)

(21) Appl. No.: 19/483,404

(22) PCT Filed: May 16, 2024
(86) PCT No.: PCT/US2024/029748

§ 371 Date: Nov. 11, 2025

Related U.S. Application Data
(60) Provisional application No. 63/467,403, filed on May 18, 2023.
(60) Provisional application No. 63/560,512, filed on Mar. 1, 2024.

(51) Int. Cl. C23C 18/12; C23C 18/04

(52) U.S. Cl. CPC C23C 18/1208; C23C 18/04; C23C 18/1233; C23C 18/1295

(57) ABSTRACT

Polymer-ceramic composite materials and methods of manufacture of such materials are provided. The polymer-ceramic materials include a polymer substrate and a ceramic within the internal volume of the polymer matrix and on the surface of the polymer.

### CROSS-REFERENCE TO RELATED APPLICATIONS

This application claims the benefit of U.S. Provisional Application No. 63/467,403, filed on May 18, 2023, and U.S. Provisional Application No. 63/560,512, filed on Mar. 1, 2024, both of which are incorporated herein by reference in their entireties.

### FIELD OF THE INVENTION

The invention relates to the deposition of ceramic onto polymer substrates, in particular, without the use of a resin or a paint, and to polymer-ceramic composites.

### BACKGROUND

Application of ceramics to polymer surfaces typically requires binder and resin for adherence. Direct application of ceramics onto polymer surfaces results in mechanical durability and thermal durability challenges. Most applications of ceramic materials onto polymers involve suspending the ceramic materials into a paint or other resin and then coating the resulting suspension onto the polymer. This approach typically covers the ceramic with resin and reduces the available surface area of the ceramic material. Additionally, this creates a sharp interface between the resin and the polymer that can act as a point of failure of the ceramic coating, such as delamination. There is a need for improved methods for deposition of ceramic materials onto polymer substrates.

### BRIEF SUMMARY OF THE INVENTION

Polymer-ceramic composites, and methods of making the composites, are provided herein.

In one aspect, a polymer-ceramic composite is provided. The composite includes: a polymer substrate, which includes a polymer matrix that has an external surface and an internal volume; and a ceramic. The polymer-ceramic composite includes ceramic on the external surface of the polymer matrix and ceramic or inorganic elements at least partially occupy the internal volume of the polymer matrix.

In some embodiments, the polymer-ceramic composite is in the form of a fiber or a film. For example, the composite may be in the form of a fiber with a mean diameter less than about 5 millimeters or less than about 1 millimeter. For example, the polymer-ceramic composite may be in the form of a film with a polymer layer mean thickness less than about 5 millimeters or less than about 3 millimeters.

In some embodiments, the polymer-ceramic composite is a fiber, a laminate, a film, a textile material, a paper, or a combination thereof. In some embodiments, the polymer substrate includes a polyester, a polyamide, a polyolefin, a substituted polyolefin, a polyurethane, a polyol, a vinyl polymer, an acrylate polymer, a polycarbonate, a polyether, cotton, wool, paper, a cellulosic material, or a combination thereof. For example, the polymer substrate may include polyethylene terephthalate (PET), a nylon, polyethylene, polypropylene, polyvinyl chloride (PVC), polyvinyl alcohol (PVOH), polyvinyl acetate (PVAc), polyvinylpyrrolidone, polyethylene glycol (PEG), polymethylmethacrylate (PMMA), cellulose, or mixtures thereof.

In some embodiments, ceramic in the polymer-ceramic composite includes a transition metal, an alkali metal, or an alkaline earth metal. In some embodiments, the ceramic includes one or more of oxide, a hydroxide, a phosphate, a layered double hydroxide, a sulfate, a carbonate, and an oxalate of a transition metal, an alkali metal, or an alkaline earth metal. In some embodiments, the ceramic includes one or more of manganese oxide, iron oxide, calcium carbonate, hydroxyapatite, calcium phosphate, calcium oxalate, magnesium carbonate, calcium sulfate, titanium oxysulfate, and magnesium sulfate. In some embodiments, the ceramic in the polymer-ceramic composite includes calcium, sodium, potassium, sulfur, chlorine, manganese, iron, nickel, magnesium, titanium, lithium, or zinc.

In some embodiments, the polymer-ceramic composite is in the form of a fiber, and is formed into or incorporated into a textile. For example, the forming or incorporating into a textile may include knitting, weaving, bonding, or entangling of polymer-ceramic composite fibers as described herein, either chemically, mechanically, by applying heat or one or more solvent(s), or by other physical means.

In some embodiments, the polymer matrix of the polymer-ceramic composite includes one or more of a polyester, a polyamide, a polyolefin, a substituted polyolefin, a polyurethane, a polyol, a vinyl polymer, an acrylate polymer, a polycarbonate, and a polyether. For example, the polymer matrix may include one or more of polyethylene terephthalate (PET), a nylon, polyethylene, polypropylene, polyvinyl chloride (PVC), polyvinyl alcohol (PVOH), polyvinyl acetate (PVAc), polyvinylpyrrolidone, and polyethylene glycol (PEG), polymethacrylate (PMMA), or mixtures thereof.

In some embodiments, the polymer matrix of the polymer-ceramic composite includes one or more of a copolymer. For example, the polymer matrix may include one or more of polyether-polyurea copolymer, nylon copolymers such as a copolymer of nylon 12, nylon 6, nylon 6/6, and/or nylon 6/12, copolyesters. acrylonitrile butadiene styrene (ABS), styrene/butadiene co-polymer (SBR), nitrile rubber, styrene-acrylonitrile, styrene-isoprene-styrene (SIS) and ethylene-vinyl acetate, or other co-polymers formed by chain-growth polymerization or step-growth polymerization.

In some embodiments, the polymer matrix of the polymer-ceramic composite includes a hydrocolloid, such as, but not limited to, a polysaccharide.

In some embodiments, the polymer matrix of the polymer-ceramic composite includes one or more of locust bean gum, starch, carrageenan, pectin, chitosan, xanthan gum, cellulose, and carboxymethyl cellulose.

In some embodiments, the polymer matrix of the polymer-ceramic composite includes one or more of wool, cotton, hemp, animal hair, collagen, keratin, silk, chitin, flax, and jute.

In some embodiments, the polymer-ceramic composite is in the form of a fiber, and the ceramic concentration relative to the polymer matrix increases radially from the center of the interior volume of the polymer matrix in the fiber to the external surface of the polymer matrix. In some embodiments, the polymer-ceramic composite is in the form of a film or a thin film, and the ceramic concentration relative to the polymer matrix increases from the center of the interior volume of the polymer matrix in the film to the external surface of the polymer matrix. In some embodiments, the polymer-ceramic composite is in the form of a laminate, and the ceramic concentration relative to the polymer matrix increases in the outermost layers of the laminate relative to inner layers. In some embodiments, the polymer-ceramic composite contains a polymer core and a shell comprising a ceramic composite material. In some embodiments, the polymer-ceramic composite is a textile that contains a polyamide, a polyester, a polyolefin, a polyurethane, a polyol, a vinyl group, cotton, wool, a cellulosic material, or a combination thereof. In some embodiments, the polymer-ceramic composite is in the form of a film, and the ceramic concentration relative to the polymer matrix increases on one side of the film relative to the opposite side of the film external surface. In some embodiments, the polymer-ceramic composite contains a core material comprising a thermoplastic, wherein the thermoplastic consists of a polyester, polyamide, polyurethane, acrylic, polyolefin, polyol, ABS, polyvinyl alcohol, or a combination thereof. In some embodiments, the polymer-ceramic composite contains a core material that includes cotton, wool, or cellulosic material, blends of natural and synthetic fibers, or combinations thereof.

In some embodiments, greater than about 20% of the ceramic in the polymer-ceramic composite by weight protrudes from the external surface of the polymer matrix, i.e., is external to the surface of the polymer substrate. For example, the composite may include a layer of the ceramic on the external surface of the polymer matrix, and the layer may be less than about 1 μm, or less than about 100 nm in thickness. The mean thickness of the ceramic layer is the distance from the external surface of the polymer substrate to the external surface of the ceramic layer. For example, the ceramic layer may be nanostructured and may have at least one feature size with a dimension that is less than about 100 nm. In some embodiments, both the ceramic layer on the external surface and ceramic that is in the internal volume of the composite may be nanostructured, for example, with at least one feature size with a dimension that is less than about 100 nm. In some embodiments, both the ceramic layer on the external surface and ceramic that is in the internal volume of the composite may include additional inorganic elements, for example, but not limited to, potassium, sodium, magnesium, chlorine, sulfur, phosphorous, or other ionic elements or compounds.

In another aspect, a method of manufacturing a polymer-ceramic composite as described herein is provided. The method includes: (a) contacting a polymer substrate with at least one solution that includes a metal salt or a metal-organic complex, and optionally, an oxidizing agent, an amine, ammonia, a penetrant, a surfactant, a release agent, or other reactive precursor(s) (such as, but not limited to, a catalyst in a solvent), or a combination thereof, wherein the solution is at least partially absorbed into the polymer matrix; (b) heating or otherwise ensuring a temperature of the polymer substrate produced in step (a) to a temperature sufficient to remove the solvent from the polymer substrate, sufficient to drive a ceramic-forming reaction with one or more of the metal salt(s), or sufficient to decompose or react the metal-organic complex, thereby forming a polymer-ceramic composite; and (c) optionally, coating the polymer-ceramic composite produced in step (b) with one or more functional layer(s) or molecules.

In some embodiments, the metal salt in step (a) may include one or more of a transition metal nitrate, a transition metal chloride, a transition metal sulfate, an alkali metal nitrate, an alkaline earth metal nitrate, an alkali metal chloride, an alkaline earth metal chloride, an alkali metal sulfate, and an alkaline earth metal sulfate. In some embodiments, the metal-organic complex in step (a) may include a metal-amine complex. In some embodiments, the amine in step (a) may include a free amine.

In some embodiments, the heating in step (b) may be at a temperature of about 30° C. to about 200° C.

In some embodiments, the functional layer in step (c) may include a monolayer chemistry wherein the functional layer is substantially a monolayer with a thickness less than about 5 nm. The mean thickness of the functional layer is the distance from the external surface of the of the ceramic layer to the external thickness of the functional layer. For example, the monolayer chemistry may include a silane, siloxane, phosphonic acid, phosphonate, sulfonate, sulfonic acid, carboxylic acid, carboxylate, urethane, vinyl group, or acrylate, or a molecule with a head group and a tail group. In some embodiments, monolayer chemistry includes a molecule with a head group and a tail group, wherein the head group includes a silane group, a phosphonate group, a phosphonic acid group, a carboxylic acid group, a vinyl group, an alcohol group, a hydroxide group, a thiolate group, a thiol group, and/or an ammonium group, and wherein the tail group includes a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group. For example, the heat group may include an ammonium group, such as a quaternary ammonium group.

In some embodiments, the functional layer in step (c) may include a polymer chemistry, for example, with a mean thickness of less than about 500 nm. The mean thickness of the functional layer is the distance from the external surface of the of the ceramic layer to the external thickness of the functional layer. For example, the functional layer chemistry may include functional molecules comprising a silane, a siloxane, a phosphonic acid, a phosphonate, a sulfonate, a sulfonic acid, a carboxylic acid, a carboxylate, a urethane, a vinyl group, or an acrylate, or a molecule with a head group and a tail group. In some embodiments, polymer chemistry includes a crosslinker molecule to improve mechanical and chemical properties. In some embodiments, polymer chemistry includes a molecule with a head group and a tail group, wherein the head group includes a silane group, a phosphonate group, a phosphonic acid group, a carboxylic acid group, a vinyl group, an alcohol group, a hydroxide group, a thiolate group, a thiol group, and/or an ammonium group, and wherein the tail group includes a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group. For example, the heat group may include an ammonium group, such as a quaternary ammonium group.

In some embodiments, the method includes formation of a polymer-ceramic composite on a first substrate in steps (a) and (b), wherein the polymer-ceramic composite on the first substrate is in the form of an interconnected nanostructured layer on the first substrate, and the method further includes contacting a second substrate with the polymer-ceramic composite in such a manner that at least a portion of the interconnected nanostructured layer is transferred to a second substrate, thereby forming a second substrate-ceramic composite. Optionally, the second substrate-ceramic composite may be coated with one or more functional layer(s) or molecule(s). In some embodiments, the first substrate is contacted with the second substrate at a suitable pressure in accordance with a standard method, such as, for example, ASTM D3359. For example, the polymer-ceramic composite on the first substrate may be contacted with the second substrate by a rolling lamination process or with a heat press at a temperature of about 40° C. to about 200° C. and a pressure of about 0.1 MPa to about 10 MPa. In some embodiments, greater than about 50%, greater than about 60%, greater than about 70%, greater than about 80%, or greater than about 90% of the interconnected nanostructured layer is transferred to the second substrate. In some embodiments, greater than about 50%, greater than about 60%, greater than about 70%, greater than about 80%, or greater than about 90% of the transferred nanostructured layer is contiguous. In some embodiments, greater than about 50%, greater than about 60%, greater than about 70%, greater than about 80%, or greater than about 90% of the transferred nanostructured layer remains interconnected.

In another aspect, a polymer-ceramic composite is provided, which includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume.

In some embodiments, the second portion of the ceramic penetrates more than about 10 nanometers from the external surface into the polymer matrix internal volume. In some embodiments, the second portion of the ceramic penetrates less than about 90% of the hydraulic diameter, from the external surface of the polymer substrate into the polymer matrix internal volume. In some embodiments, the ceramic concentration decreases when measured from the external surface of the polymer substrate into the polymer matrix internal volume. For example, the ceramic concentration may decrease at a decreasing rate from the external surface of the polymer substrate into the polymer matrix internal volume. For example, the ceramic concentration may decrease as an exponential decay from the surface into the polymer matrix internal volume, such as with an exponential decay constant that is greater than about 0.01.

In some embodiments, the second portion of the ceramic contains at least about 1% of the mass of the ceramic and/or the first portion of the ceramic contains less than about 99% of the mass of the ceramic.

In some embodiments, the ceramic includes a metal and atomic mole percentage of the metal inside the polymer matrix internal volume at a depth of about 10 nm into the polymer matrix internal volume from the external surface is greater than about 0.1% In some embodiments, the ceramic includes a metal and atomic mole percentage of the metal has a discontinuity at the external surface of the polymer substrate when measured from the external surface into the polymer matrix internal volume. In some embodiments, the polymer matrix internal volume includes both convex and concave Gaussian geometric features, the ceramic includes a metal, and atomic mole percentage of the metal in the convex features is equal to or greater than the atomic mole percentage of the metal in the concave features. In some embodiments, the ceramic includes a metal, and the diffusion length of the metal is greater than about 1 μm in the polymer matrix internal volume. In some embodiments, the ceramic includes a metal, and the diffusion coefficient of the metal in the polymer matrix internal volume is less than about 10⁻⁸ m²/s.

In some embodiments, mass of the ceramic, as a percentage of mass of the polymer-ceramic composite, is less than about 10%. In some embodiments, the ceramic contains less than about 10 grams per square meter of nominal geometric surface area of the polymer-ceramic composite.

In some embodiments, the polymer-ceramic composite further includes a functional molecule. For example, the functional molecule may include a silane, a siloxane, a phosphonic acid, a phosphonate, a sulfonate, a sulfonic acid, a carboxylic acid, a carboxylate, a urethane, a vinyl group, an acrylate, or a molecule with a head group and a tail group. In certain embodiments, the functional molecule includes a molecule with a head group and a tail group, wherein the head group includes a silane group, a phosphonate group, a phosphonic acid group, a carboxylic acid group, a vinyl group, an alcohol group, a hydroxide group, a thiolate group, a thiol group, and/or an ammonium group (for example, a quaternary ammonium group), and wherein the tail group includes a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group.

In some embodiments, at least a portion of the functional molecule occupies the polymer matrix internal volume. In certain embodiments, the functional molecule penetrates more than 10 nanometers into the polymer matrix internal volume.

In some embodiments, the functional molecule concentration decreases when measured from the external surface of the polymer substrate into the polymer matrix internal volume. In one embodiment, the functional molecule concentration decreases at a decreasing rate from the external surface of the polymer substrate into the polymer matrix internal volume. In one embodiment, the functional molecule penetrates a shorter distance into the polymer matrix internal volume in comparison to an identical polymer substrate that does not contain the ceramic. In one embodiment, the functional molecule diffusion coefficient in the polymer matrix internal volume is greater than about 5% less than the diffusion coefficient of the functional molecule in an identical polymer substrate that does not contain the ceramic.

In some embodiments, the ceramic of the polymer-ceramic composite includes a transition metal, an alkali metal, or an alkaline earth metal, such as, but not limited to, calcium, manganese, phosphorous, iron, nickel, magnesium, titanium, lithium, or zinc. In some embodiments, the ceramic contains an oxide, a hydroxide, a layered double hydroxide, a phosphate, an oxalate, a sulfate, or a carbonate of the transition metal, the alkali metal, or the alkaline earth metal, or a combination thereof.

In some embodiments, at least a portion of the external surface of the polymer substrate does not include the first portion of the ceramic, e.g., at least a portion of the external surface of the polymer substrate is devoid of ceramic.

In some embodiments, at least a portion of the polymer-ceramic composite has a sessile drop water contact angle greater than about 90 degrees. In some embodiments, at least a portion of the polymer-ceramic composite has a rugosity ratio greater than about 1.3.

In some embodiments, the polymer substrate is a textile material, a thin film, a laminate, or a combination thereof. In some embodiments, the polymer substrate is a textile material. In some embodiments, the polymer-ceramic composite is a textile material that includes a polyamide, a polyester, a polyolefin, a substituted polyolefin, a polyurethane, a polyol, a vinyl group, cotton, wool, a cellulosic material, or a combination thereof.

In some embodiments, tear strength, tensile strength, gas permeability, vapor permeability, and/or abrasion resistance is improved relative to the polymer substrate. In some embodiments, tear strength, tensile strength, gas permeability, vapor permeability, and/or abrasion resistance is improved in comparison to an identical polymer-ceramic composite that does not include the functional molecule. In some embodiments, the tear strength is greater than about 1000 gF.

In some embodiments, the polymer-ceramic composite is in a core and shell configuration, wherein the polymer substrate, which includes a polymer matrix that has an external surface and an internal volume, is the core, and a ceramic, which includes ceramic on the external surface of the polymer matrix and ceramic or inorganic elements at least partially occupying the internal volume of the polymer matrix, is the shell. In some embodiments, the polymer-ceramic composite is in a film and coating configuration, where in the polymer substrate, which includes a polymer matrix that has an external surface and an internal volume, is the film, and a ceramic, which includes ceramic on the external surface of the polymer matrix and ceramic or inorganic elements at least partially occupying the internal volume of the polymer matrix, is a coating that is applied to one or more external surfaces of the polymer substrate.

In another aspect, a polymer-ceramic composite is provided that includes core and a shell, wherein the core includes a polymer and the shell includes a ceramic. In some embodiments, the shell has a thickness less than 20% of the hydraulic diameter of the core. In some embodiments, the shell has a thickness less than about 1 micrometer. In some embodiments, the core has a diameter or thickness greater than about 1 micrometer.

In some embodiments, the core contains a thermoplastic, such as, but not limited to, a polyester, a polyamide, a polyurethane, an acrylic (poly acrylate), a polyolefin, a polyol, acrylonitrile butadiene styrene (ABS), or a combination thereof. In some embodiments, the core contains cotton, wool, or a cellulosic material.

In some embodiments, the cross-section of the core is circular with a roundness greater than or greater than about 0.7, or semicircular with a semicircularity greater than or greater than or greater than about 0.7, or lobular with lobularity greater than or greater than about 0.7.

In some embodiments, the ceramic in the shell includes a transition metal, an alkali metal, or an alkaline earth metal, such as, but not limited to, iron, magnesium, zinc, manganese, calcium, nickel, titanium, lithium, or a combination thereof. In some embodiments, the transition metal, alkali metal, or alkaline earth metal is in the form of an oxide, a hydroxide, a phosphate, a carbonate, a sulfate, an oxalate, a layered double hydroxide, or a combination thereof, such as, but not limited to, manganese oxide, iron oxide, calcium carbonate, hydroxyapatite, calcium phosphate, calcium oxalate, magnesium carbonate, calcium sulfate, magnesium sulfate, or a combination thereof.

In some embodiments, weight fraction of ceramic in the shell is less than about 0.9. In some embodiments, at least one dimension of the ceramic is less than about 100 nanometers. In some embodiments, the ceramic in the shell contains a 0-dimensional, 1-dimensional, or 2-dimensional morphology.

In some embodiments, the shell further includes a siloxane, an acrylate, a phosphonate, a sulfonate, a urethane, or a combination thereof. In some embodiments, the shell further includes a silicone polymer, an alkyl-terminated silane, or an alkyl-terminated siloxane. In some embodiments, the shell further includes an alkyl-terminated functional group, such as, but not limited to, an alkyl-terminated functional group that includes an alkyl group greater than three carbon atoms. In some embodiments, the shell further includes an isocyanate or an isocyanate-terminated polymer.

In some embodiments, the shell is chemically bound to the core.

In some embodiments, the polymer-ceramic composite has a surface roughness greater than 1.1.

In some embodiments, at least a portion of the ceramic is interconnected. In one embodiment, more than 50% of the ceramic on a particle basis is interconnected.

In some embodiments, the ceramic includes crystalline domains, and in some embodiments, one or more of the crystalline domains include crystalline particles. In some embodiments, the crystalline domains are embedded in an amorphous matrix. For example, the amorphous matrix may contain at least two elements not including carbon, hydrogen, oxygen or nitrogen, that are present in the crystalline domains. In some embodiments, the amorphous matrix contains three common elements not including carbon, hydrogen, oxygen, or nitrogen, with the crystalline particles or crystalline domains. In some embodiments, the crystalline domains range in size from about 2 nm in nominal dimension to about 200 nm in nominal dimension. In some embodiments, the crystalline domains include a rare earth metal, a transition metal, an alkali metal, an alkaline earth metal, or a combination thereof, such as, but not limited to, Ca, Zn, Ni, Li, Mg, Ti, Mn, or a combination thereof. In some embodiments, the crystalline domains include a phosphate group (e.g., a polyphosphate, a pyrophosphate, a hydrogen phosphate, a dihydrogen phosphate, an orthophosphate, or a combination thereof), a carbonate group, a sulfate group, or a combination thereof. In some embodiments, the amorphous matrix includes calcium and/or phosphorus. In some embodiments, the crystalline domains include octacalcium phosphate, hydroxyapatite, monetite, brushite, calcium triphosphate, calcium pyrophosphate, and/or hydrates thereof.

In another aspect, an assembly of composites is provided that contains a plurality of polymer-ceramic composites as described herein. In some embodiments, at least a portion of the polymer-ceramic composites are in the form of fibers, which in certain embodiments may be assembled into yarns, woven textiles, knit textiles, paper, or non-woven textiles.

### BRIEF DESCRIPTION OF THE DRAWINGS

FIGS. 1a-1b show the results of deposition of a structured ceramic on a nylon substrate, as described in Example 1. FIG. 1a: SEM image of a fiber cross section. FIG. 1b: Fiber cross section SEM−EDS contour profiles for carbon (top left), silicon (top right), calcium (bottom left), and phosphorous (bottom right).

FIGS. 2a-2b show the results of evaluation of spray rating of polymer-ceramic composite structures prepared as described in Example 1. FIG. 2a: Contact angle measurement. FIG. 2b: AATCC 22 Spray rating as function of total solution contact by immersion time pre- and post-household wash (3×).

FIG. 3 shows a SEM image of a processed fabric sample section.

FIGS. 4a-4f show the analysis of a calcium phosphate polymer-ceramic composite sample. FIG. 4a: FIB cross section showing an EDS region of interest. FIG. 4b: cross section of sample after Ga FIB. FIG. 4c: 67 nm FOV image showing domains and lattice spacings. FIG. 4d: 67 nm FOV image showing domains and lattice spacings. FIG. 4e: EDS profile. FIG. 4f: EDS map—potassium (K)

FIGS. 5a-5c show cross sections of fiber samples. FIG. 5a: 1 cycle cross section. FIG. 5b: 3 cycles fiber cross section. FIG. 5c: 5 cycles fiber cross section

FIG. 6 shows a SEM exemplar image

FIG. 7 shows EDS overlay plots of fabric sections showing Ca (top) and Ti (bottom) for single cycle samples (left) and three cycle samples (right).

FIGS. 8a-8e show SEM exemplar images of interconnected nanostructured layers formed on a polymer (cellulose) substrate. FIG. 8e shows the interconnected nanostructured layers remaining on the polymer (cellulose) substrate after tape adhesion. FIG. 8f is a SEM exemplar image of an interconnected nanostructured layer transferred to a polymer substrate from an interconnected nanostructured layer on a polymer (cellulose) substrate.

### DETAILED DESCRIPTION

Methods are described for the deposition of ceramic onto polymer substrates without the use of a resin or a paint to prepare polymer-ceramic composites. Polymer-ceramic composites are described that include one or more ceramic deposited onto the external surface of a polymer substrate. The ceramic deposited onto the polymer substrate typically also penetrates the interior volume of the polymer substrate, i.e., is integrated within the polymer matrix internal volume, thereby increasing durability and adhesion in comparison to a ceramic coating that adheres solely, or largely, to the external surface of the polymer substrate. In some embodiments, one or more complementary inorganic elements penetrate the ceramic on the polymer substrate and the polymer matrix internal volume. In some embodiments, one or more complementary inorganic elements penetrate the ceramic. In some embodiments, one or more complementary inorganic elements penetrate the ceramic on the polymer substrate. In some embodiments, one or more complementary inorganic elements penetrate the ceramic on the external surface of the polymer substrate. In some embodiments, one or more complementary inorganic elements penetrate the ceramic which occupies at least a portion of the polymer matrix internal volume. In some embodiments, one or more complementary inorganic elements penetrate the ceramic on the external surface of the polymer substrate and the ceramic which occupies at least a portion of the polymer matrix internal volume. In some embodiments, one or more complementary inorganic elements penetrate the polymer matrix internal volume. In some embodiments, one or more complementary inorganic elements penetrate the ceramic and the polymer matrix internal volume. In some embodiments, the complementary inorganic elements include potassium, magnesium, chlorine, bromine, iodine, phosphorus, sulfur, nitrogen, oxygen, carbon, hydrogen, manganese, aluminum, titanium, sodium, calcium, or a combination thereof.

In some embodiments, ceramic is added to the polymer substrate prior to melting, extrusion, drawing or spinning the polymer, or other processing methods as described herein. The ceramic is typically in a powder or particulate form and may be added to alter functional properties of the polymer, such as, but not limited to, color, optical properties, electrical conductivity, catalytic or photocatalytic properties, or to provide or enhance antimicrobial properties of the base polymer. Typically, the methods described herein involve a reaction of chemicals in the presence of the polymer substrate in order to generate a ceramic material in situ and conformally around and within the polymer substrate, that is, on the external surface and occupying a portion of the polymer matrix internal volume, improving the adhesion without melting or pressing the ceramic into the polymer substrate,

The methods herein may be performed on polymer substrates which have had ceramics previously integrated, such as by blending, drawing, casting, or other mechanical addition methods, or may be performed on polymer substates which do not include previously integrated ceramic material.

### Definitions

Numeric ranges provided herein are inclusive of the numbers defining the range.

“A,” “an,” and “the” include plural references unless the context clearly dictates otherwise.

Unless otherwise stated, average values herein refer to number averages.

The phrase “and/or,” as used herein in the specification and in the claims, should be understood to mean “either or both” of the elements so conjoined, i.e., elements that are conjunctively present in some cases and disjunctively present in other cases. Additional elements may optionally be present other than the elements specifically identified by the “and/or” clause, whether related or unrelated to those elements specifically identified, unless clearly indicated to the contrary. Thus, as a non-limiting example, a reference to “A and/or B,” when used in conjunction with open ended language such as “comprising” can refer, in one embodiment, to A without B (optionally including elements other than B); in another embodiment, to B without A (optionally including elements other than A); in yet another embodiment, to both A and B (optionally including other elements); etc.

“0-dimensional materials” are materials where all the dimensions of the material are less than about 100 nm and typically boundary or edge properties are important. Example materials are quantum dots.

“Agglomerate” or “agglomerated” refers to a collection of previously discrete particles or materials which when contacted remain connected and undergo some degree of coalescence, relative incorporation, or growth.

“Aggregate” or “aggregated” refers to a collection of previously discrete particles or materials that when contacted remain connected but do not appear to undergo an additional coalescence, relative incorporation, or growth.

“Air permeability” is the rate of air transmission through a fabric according to ASTM D737 or similar methods. The rate is reported in volumetric flow per unit time, typically in cubic feet per minute, or cfm.

“Atomic percentage” refers to the number of atoms of one or more specifically named elements as a percentage of the total number of atoms present within a specified area or volume.

A “ceramic” or “ceramic material” refers to a solid material including an inorganic compound of a metal or a metalloid, and a non-metal, with ionic or covalent bonds. In this context, “ceramics” may include amorphous inorganic glasses, glass-ceramics, polycrystalline materials, and combinations thereof. Ceramics may contain at least one type of functional crystalline phase and a residual glass phase with the volume fraction crystallized may vary from ppm to almost 100%. A “non-metal” may include oxygen (oxide ceramic), or carbon (carbide) or nitrogen (nitride) (non-oxide ceramics). A “metal” may include a non-hydrogen element of Group 1 of the periodic table, an element of Groups 2-12 of the periodic table, or an element from the p-block (Groups 12-17 of the periodic table), e.g., Al, Ga, In, TI, Sn, Pb, Bi, or combinations thereof. A “metalloid” may include B, Si, Ge, As, Sb, Se, Te, or Po, or combinations thereof.

“Circularity” has a value from 0 to 1 and is defined as 4π*Cross section area/Perimeter². A perfect circle would have a circularity value of 1. A perfect semicircle has a circularity of 0.5 and a semicircularity ranging from 0 to 1 is defined as 8π*Cross section area/Perimeter². Semicircular fiber cross sections may be formed by extrusion, asymmetric fiber pulling, calendaring, or other thermomechanical methods.

“Complementary inorganic element” refers to an element present in a counterion, where a ceramic precursor includes one or more ions incorporated into the ceramic and one or more counterions that are not incorporated into the ceramic. For example, in some embodiments, the ceramic precursors include calcium chloride and/or calcium nitrate, calcium ions are incorporated into the ceramic, the counterions chloride and nitrate are not incorporated into the ceramic, and the complementary inorganic elements include chlorine, nitrogen, and/or oxygen. In a further example, in some embodiments, the ceramic precursors include ammonium dihydrogen phosphate, dihydrogen phosphate ions are incorporated into the ceramic, the counterion ammonium is not incorporated into the ceramic, and the complementary inorganic elements include nitrogen and/or hydrogen.

“Concave Gaussian geometric features” refers to geometric surface features that nominally penetrate into the surface of a substrate, are concave when viewed along a line of sight from above the surface to the surface and nominally orthogonal to the surface, and which can be described by a Gaussian expression.

“Convex Gaussian geometric features” refers to geometric surface features that nominally protrude from the surface of a substrate, are convex when viewed along a line of sight from above the surface to the surface and nominally orthogonal to the surface, and which can be described by a Gaussian expression.

“Contact angle” refers to the angle measured through a liquid from the surface and to the liquid-vapor interface at the contacting surface. The sessile drop method is the standard method of contact angle measurement in which the droplet used to characterize the surface is stationary.

“dtex” or (deci-tex) is a direct measure of the linear density, defined as grams per 10,000 meters of yarn. dtex=10*Tex=denier/0.9

The “diffusion coefficient” is a physical constant dependent on molecule size, properties of the diffusing substance, temperature, and pressure and is typically determined experimentally.

The “diffusion length” is a characteristic length which provides a measure of how far the concentration has propagated in a single dimension by a specific time. A common equation to determine this is 2\sqrt{Dt} where D is the diffusion coefficient, and t is time.

A “functional material layer” refers to a layer of material which may serve as the uppermost surface layer interacting with the surrounding environment or may serve as an interfacial layer for subsequent materials (intermediate layer between two other layers of material). A functional material layer imparts one or more desirable functional properties to the underlying substrate and/or to the material on which it is deposited.

A “gradient” refers herein to a quantitative increase or decrease in one or more physical or chemical property of a material observed by passing spatially from one point to another point along a substrate surface on which the material is situated or immobilized, and varying in an x, y, or z direction in Cartesian coordinates on or through the material. Nonlimiting examples of gradient properties include thickness, density, hardness, ductility, pore size, pore size distribution, pore filling fraction, or chemical or physical composition, including but not limited to, oxidation state, metal concentration, or crosslinking density, for example, resulting in variation in isoelectric point, electrical conductivity, thermal conductivity, capacitance, etc.

“Hydraulic diameter” refers to a value that is 4 times the cross-sectional area divided by the perimeter of the cross-sectional area. In the case of a nominally cylindrical fiber of circular cross section, the hydraulic diameter is 2 times the radius of the circular cross-section.

“Hydrophilic” refers to a surface that has a high affinity for water. Contact angles can be very low (i.e., less than 30 degrees as measured from the surface through the liquid water in the presence of air) and/or immeasurable.

“Interconnected” refers to a network or matrix of ceramic material, wherein ceramic material in the network is in physical contact with (connected to) other ceramic material in the network, i.e., a majority of ceramic material is adjoined to other ceramic material resulting in a scaffolded structure either free-standing or supported on a substrate. The interconnected ceramic network described herein is a continuous ceramic phase over an area or volume defined by lengths greater than 100 mean particle diameters, and may contain pores (open spaces) with an accessible pore volume, which may be filled, or partially filled, with another material, such as, but not limited to, a polymer.

“Layered double hydroxide” refers a class of ionic solids characterized by a layered structure with the generic sequence [AcB Z AcB]ₙ, where c represents layers of metal cations, A and B are layers of hydroxide anions, and Z are layers of other anions and/or neutral molecules (such as water). Layered double hydroxides are also described in PCT Application No. PCT/US2017/052120, which is incorporated by reference herein in its entirety.

“Lobularity” is the deviation from the designed fiber cross sectional shape. Lobularity refers herein to (CVᵣ²)_{design}/(CVᵣ²)_{actual} and has a value of 0 to 1. CVᵣ², as defined in Wang. Z., et al. (2012) Texlife Research Journal 82(5):454-462. Several different classes and examples of non-cylindrical fiber shapes including trilobal shapes, multi-leaf shapes, slender shapes and shapes with deep depressions are provided. Fiber shape factors (Perimeter²/Area) may be used to define non-standard fiber shapes.

“Laminate” refers to a structure or composite that includes one or more thin layers affixed to other thin layers, or to structural layers, or to a substrate.

“Mean” refers to the arithmetic mean or average.

A “nanostructured” coating refers to a coating composition that has a feature in at least one dimension that is less than 100 nanometers.

“Nominal” is used to refer to approximate sizes or dimensions of a material; the actual dimensions may be larger or smaller than the nominal dimension. When nominal dimensions are used to describe nanomaterials, the nominal dimension is the largest single dimension of the nanomaterial, such as the diameter of a sphere, or the length of a plate. When nominal is used to describe materials such as fabrics, the term nominal is used to refer to the approximate value or measurement of the most prevalent feature, but not necessarily the exact measurement. An example is the nominal surface area of a fabric. The nominal surface area is defined by the length multiplied by the width of the fabric, and does not account for any increase in surface area as would be provided the fibers that make up the fabric.

“Rugosity ratio”, is the ratio of the rugosity of a polymer-ceramic composite to the rugosity of the polymer substrate. Rugosity is a measure of small-scale variations of amplitude in the height of a surface, and is a ratio of Aᵣ the real (true, actual) surface area and A_{g} the geometric surface area.

“Surface roughness” or “roughness factor” is the measurement of the relative smoothness of a surface's profile, calculated via the deviations (macroscopic or microscopic) in a surface's true or ideal form. The larger the deviation from the ideal form, the larger the surface roughness. A surface roughness factor commonly used is Rₐ which is defined as the arithmetic average of profile height deviations from the mean line. This is the term used throughout this application when not otherwise specified.

“Textile” is a term that includes various fiber-based materials including fibers, yarns, filaments, threads that are combined or manufactured to create a flexible polymeric film, garment, or fabric. Textiles or textile materials can be described as woven or non-woven whereas fabrics are a subset of textiles which include only woven fibers, yarns, filaments or threads.

“Thickness” of a material (e.g., the first or second material as described herein) refers to the nominal distance between top and bottom edges or surfaces of a material, such as the surface defined by the edge of the interfacial layer in contact with the substrate or first material in the case of a second material, and the nominal top surface of the layer of surface modification material.

“Tunable” refers to the ability of a function, characteristic, or quality of a material to be changed or modified.

### Polymer Substrate

In some embodiments, the polymer substrate onto which a ceramic is deposited as described herein is hydrophilic. For example, the hydrophilic polymer may include one or more hydroxide group(s).

In some embodiments, the polymer substrate onto which a ceramic is deposited as described herein is hydrophobic. In some embodiments, the hydrophobic polymer substrate includes one or more acrylic, amide, imide, carbonate, diene, ester, ether, fluorocarbon, olefin, styrene, and/or vinyl group(s). In some embodiments, the hydrophobic polymer substrate includes one or more arylalkyl groups, as would be present if the monomer used to form the polymer substrate contained styrene or a substituted styrene, and as exemplified by the polymer substrate formed by polymerizing styrene and containing phenylalkyl groups. In some embodiments, the hydrophobic polymer substrate includes one or more ester groups, as would be present if the monomer used to form the polymer substrate contained a carboxylic acid ester of vinyl alcohol or a carboxylic acid ester of a substituted vinyl alcohol, and as exemplified by the polymer substrate formed by polymerizing vinyl acetate and containing the polyacetate of a polyalcohol. In some embodiments, the hydrophobic polymer substrate includes one or more ester groups, as would be present if the monomer used to form the polymer substrate contained an ester of acrylic acid or of a substituted acrylic acid, and as exemplified by the polymer substrate formed by polymerizing methyl acrylate and containing the polymethylester of a polyalkylcarboxylic acid. In some embodiments, the hydrophobic polymer substrate includes one or more olefin groups, as would be present if the monomer used to form the polymer substrate includes a diene or a substituted diene, and as exemplified by the polymer substrate formed by polymerizing 1,3-butadiene and containing alkyl chains or side-chains comprising olefinic groups.

In some embodiments, the polymer substrate onto which a ceramic is deposited as described herein is a copolymer. For example, the copolymer may be amphiphilic and include one or more polymer compound(s), such as poly(ethylene glycol)-b-poly(lactic acid) (PEG-PLA). In some embodiments, the polymer substrate onto which a ceramic is deposited as described herein includes a polymer blend. In some embodiments, the polymer blend is a blend of two or more homopolymers. In some embodiments, the polymer blend is a blend of two or more copolymers. In some embodiments, the polymer blend is a blend of one or more homopolymers and one or more copolymers.

In some embodiments, the polymer substrate onto which a ceramic is deposited as described herein is at least partially composed of an elastomer. For example, the substrate may be a styrene elastomer fiber, a polyester elastomer fiber, or a nylon elastomer fiber.

In some embodiments, the polymer substrate onto which a ceramic is deposited as described herein is at least partially composed of a resin. For example, the substrate may be a liquid crystal polymer, an acrylic resin fiber, or other resin based fiber. In some embodiments, the polymer substrate onto which a ceramic is deposited as described herein is a manufactured fiber, e.g., spun from a liquid-crystal polymer (LCP). For example, in one embodiment, the substrate may be Vectran®, an aromatic polyester produced by the polycondensation of 4-hydroxybenzoic acid and 6-hydroxynaphthalene-2-carboxylic acid.

In some embodiments, the polymer substrate onto which a ceramic is deposited as described herein is composed primarily of a carbon fiber. For example, the substrate may be activated carbon fiber (ACF). In some embodiments, the polymer substrate onto which a ceramic is deposited as described herein is composed of crystalline filaments of carbon in many forms, including but not limited to woven fabrics, braids, and unidirectional sheets. In some embodiments, the polymer substrate onto which a ceramic is deposited as described herein is a composite of primarily carbon fiber and resins. In some embodiments, various base materials such as, but not limited to carbon, fiberglass, or Kevlar®, which have been pre-impregnated with a resin system, are used as the polymer substrate. In some embodiments, the polymer substrate onto which a ceramic is deposited as described herein is a composite of carbon and alternative fibers such as glass which may contain resin.

In some embodiments, the polymer substrate may include one or more polymer(s) in a composite construction, for example, including different yarn or fiber materials. One such example is a carbon fiber—nylon ripstop fabric where the body of the fabric is primarily composed of nylon fibers and the ripstop fibers are primarily composed of carbon fibers.

In some embodiments, the polymer substrate can absorb water or another solvent, as determined by an increase in mass after submersion in the water or solvent. In some embodiments, the polymer substrate can swell when submerged in water or another solvent. In some embodiments, the solvent that is absorbed or that swells the polymer substrate may include water, an alcohol, acetone, dimethyl carbonate, methyl acetate, tert-butyl acetate, propylene carbonate, acetic acid, methyl ethyl ketone, or mixtures thereof. In some embodiments, the solvent includes an alcohol, such as, but not limited to, ethanol, methanol, isopropanol, butanol, isobutanol, propylene glycol, glycol ether, or 2-ethylhexanol, 2-butoxyethanol, or mixtures thereof.

In some embodiments, the polymer substrate absorbs water or a solvent that contains water and one or more cosolvents. In some embodiments, the polymer substrate swells in water or a solvent that contains water and one or more cosolvents. In some embodiments, the one or more cosolvents include an alcohol, a ketone, a dialkyl carbonate, an alkyl carboxylic acid, an alkyl ester of an alkyl carboxylic acid, an alkyl diol, an ether, or mixtures thereof. In some embodiments, the alcohol includes methanol, ethanol, propanol, isopropanol, butanol, isobutanol, 2-butoxyethanol, 2-ethylhexanol, or mixtures thereof. In some embodiments, the alcohol includes methanol. In some embodiments, the ketone includes acetone and/or methyl ethyl ketone. In some embodiments, the dialkyl carbonate includes dimethyl carbonate, diethyl carbonate, ethyl methyl carbonate, ethylene carbonate, propylene carbonate, or mixtures thereof. In some embodiments, the alkyl carboxylic acid includes formic acid, acetic acid, propionic acid, or mixtures thereof. In some embodiments, the alkyl ester of an alkyl carboxylic acid includes methyl acetate, ethyl acetate, propyl acetate, isopropyl acetate, butyl acetate, sec-butyl acetate, tert-butyl acetate, methyl propionate, ethyl propionate, or mixtures thereof. In some embodiments, the alkyl diol includes ethylene glycol, propylene glycol, 1,2-butanediol, 1,3-butanediol, 1,4-butanediol, or mixtures thereof. In some embodiments, the ether includes tetrahydrofuran, ethylene glycol butyl ether [HO(CH₂)₂O(CH₂)₃CH₃, 2-butoxyethanol, EGBE], diethylene glycol [HO(CH₂)₂O(CH₂)₂OH], diethylene glycol monobutyl ether [2-(2-butoxyethoxy)ethan-1-ol, HO(CH₂)₂O(CH₂)₂O(CH₂)₃CH₃, DEGBE], a diethylene glycol monoalkyl ether, HO(CH₂)₂O(CH₂)₂O(CH₂)ₙCH₃, where n=0, 1, 2, or 4, or mixtures thereof. In some embodiments, the ether includes EGBE. In some embodiments, the ether includes DEGBE. In some embodiments, the ether includes a mixture of EGBE and DEGBE.

In some embodiments, the polymer substrate includes a polyester such as polyethylene terephthalate (PET), a polyamide such as a nylon, polyvinyl chloride (PVC), a polyolefin such as polyethylene or polypropylene, a polyurethane, polyvinyl alcohol (PVOH), polyvinyl acetate (PVAc), polyvinylpyrrolidone, a polyol, polyethylene glycol (PEG), or mixtures and/or copolymers thereof. In some embodiments, the nylon is nylon-6, nylon-6,6, or nylon-12 or copolymers thereof. In some embodiments the nylon is nylon-6,6. In some embodiments the polyamide is the product of condensation of hexamethylenediamine and terephthalic acid or the condensation of paraphenylenediamine and terephthalic acid. In some embodiments, the polymer is a copolymer of more than one monomer such as nylon, acrylonitrile butadiene styrene (ABS), styrene/butadiene copolymer (SBR), nitrile rubber, styrene-acrylonitrile, styrene-isoprene-styrene (SIS) or mixtures thereof. In other embodiments, the polymer substrate includes a hydrocolloid, such as a polysaccharide. In some embodiments, the polymer substrate includes locust bean gum, a starch, carrageenan, pectin, chitosan, xanthan gum, cellulose, or carboxymethyl cellulose, or mixtures thereof. In some embodiments, the polymer includes wool, cotton, hemp, animal hair, collagen, keratin, silk, chitin, flax, or jute, or mixtures thereof.

In some embodiments, the polymer substrate includes locust bean gum, a starch, carrageenan, pectin, chitosan, xanthan gum, cellulose, or carboxymethyl cellulose, or mixtures thereof. In some embodiments, the polymer includes wool, cotton, hemp, animal hair, collagen, keratin, silk, chitin, flax, or jute, or mixtures thereof.

In some embodiments, the polymer substrate containing cellulose or carboxymethyl cellulose includes paper, a thin sheet material produced by processing cellulose fibers derived from wood, rags, grasses, or other vegetable sources such as cotton, banana, or hemp. In some embodiments, cellulose fibers may be refined from natural materials by chemical processing, thermal processing, mechanical processing, or combinations therein. In some embodiments, cellulose fibers may be recycled from paper, newsprint or cardboard for reuse. In some embodiments, cellulose fibers may be blended with other natural or synthetic materials such as gypsum, starch, or polymer fibers to modify the properties of the paper. In some embodiments, polymer substrates containing cellulose may also be mixed and otherwise bonded to other materials including resin, lignin, and starch. In some embodiments, polymer substrates containing cellulose may include other non-cellulose containing materials including woven glass, minerals, textiles, or polymer fibers such as polyvinyl alcohol or polyvinyl acetate. In some embodiments, polymer substrates containing cellulose may include other natural materials including silk, carrageenan, or starches. In some embodiments, polymer substrates containing cellulose are coated, treated or finished with processes and materials to promote color, adhesion, absorption, fire retardancy, reduced weight, increased strength, sound dampening, or other properties. In some embodiments, polymer substrates may contain cellulose that has been reacted to form other products such as carboxymethyl cellulose (CMC) or cellulose gum where carboxymethyl groups (—CH2-COOH) bound to some of the hydroxyl groups of the glucopyranose monomers that make up the cellulose backbone. For example, CMC may be synthesized by the alkali-catalyzed reaction of cellulose with chloroacetic acid. In some embodiments, polymer substrates containing cellulose such as cotton or viscose rayon are converted into CMC.

In some embodiments, the polymer substrate includes one or more copolymers. In some embodiments, the copolymer includes a polyether-polyurea copolymer, a polyamide copolymer, a polyester copolymer, an acrylonitrile butadiene styrene (ABS) copolymer, a styrene/butadiene copolymer (SBR), a nitrile rubber, a styrene-acrylonitrile copolymer, a styrene-isoprene-styrene (SIS) copolymer, an ethylene-vinyl acetate copolymer, or combinations thereof. In some embodiments, the copolymer includes a copolymer formed by chain-growth polymerization and/or a copolymer formed by step-growth polymerization.

In some embodiments, the polyamide copolymer is the copolymer that could be formed by condensation polymerization of two or more dicarboxylic acids and a diamine, a dicarboxylic acid and two or more diamines, or two or more dicarboxylic acids and two or more diamines. In some embodiments, the polyamide copolymer is the copolymer that could be formed by condensation polymerization of two or more dicarboxylic acids and a diamine, a dicarboxylic acid and two or more diamines, or two or more dicarboxylic acids and two or more diamines, wherein the dicarboxylic acid(s) is/are selected from adipic acid, sebacic acid, 1,12-dodecanedioic acid, terephthalic acid, and isophthalic acid, and wherein the diamine(s) is/are selected from 1,4-diaminobutane, 1,5-diaminopentane, 2-methylpentamethylenediamine, hexamethylenediamine (1,6-diaminohexane), meta-xylenediamine, 1,9-diaminononane, 1,10-diaminodecane, 1,12-diaminododecane, 4,4′-methylenedi(cyclohexan-1-amine), and trimethylhexamethylenediamine. In some embodiments, the polyamide copolymer is the copolymer that could be formed by condensation polymerization of one or more aminocarboxylic acids or the corresponding lactams, one or more dicarboxylic acids, and one or more diamines. In some embodiments, the polyamide copolymer is the copolymer that could be formed by condensation polymerization of one or more aminocarboxylic acids or the corresponding lactams, one or more dicarboxylic acids, and one or more diamines, wherein the aminocarboxylic acid or the corresponding lactam is selected from caprolactam, 11-aminoundecanoic acid, and o-aminolauric acid, wherein the dicarboxylic acid is selected from adipic acid, sebacic acid, dodecanedioc acid, terephthalic acid, and isophthalic acid, and wherein the diamine is selected from 1,4-diaminobutane, 1,5-diaminopentane, 2-methylpentamethylene-diamine, hexamethylenediamine (1,6-diaminohexane), meta-xylenediamine, 1,9-diaminononane, 1,10-diaminodecane, 1,12-diaminododecane, 4,4′-methylenedi(cyclohexan-1-amine), and trimethyl-hexamethylenediamine. In some embodiments, the polyamide copolymer is the copolymer that could be formed by condensation polymerization of two or more aminocarboxylic acids or the corresponding lactams, In some embodiments, the polyamide copolymer is the copolymer that could be formed by condensation polymerization of two or more aminocarboxylic acids or the corresponding lactams, wherein the aminocarboxylic acids or the corresponding lactams are selected from caprolactam, 11-aminoundecanoic acid, and o-aminolauric acid. In some embodiments, the polyamide copolymer is the copolymer that could be formed by condensation polymerization of caprolactam and 11-aminoundecanoic acid. In some embodiments, the polyamide copolymer is the copolymer that could be formed by condensation polymerization of caprolactam and (o-aminolauric acid. In some embodiments, the polyamide copolymer is the copolymer that could be formed by condensation polymerization of caprolactam, adipic acid, and hexamethylenediamine. In some embodiments, the polyamide copolymer is the copolymer that could be formed by condensation polymerization of co-aminolauric acid, adipic acid, and hexamethylenediamine. In some embodiments, the polyamide copolymer is the copolymer that could be formed by condensation polymerization of caprolactam, co-aminolauric acid, adipic acid, and hexamethylenediamine.

In some embodiments, the polymer substrate includes a blend of one or more polymer and/or copolymer. In some embodiments, the blend includes a blend of two or more polyamides, or two or more nylons. In some embodiments, the blend of two or more polyamides is composed of any two or more of the polyamides that could be derived from caprolactam (nylon-6), 11-aminoundacanoic acid (nylon-11), o-aminolauric acid (nylon-12), adipic acid and hexamethylenediamine (nylon-6,6), sebacic acid and hexamethylenediamine (nylon-6,10), dodecanedioic acid and hexamethylenediamine (nylon-6,12), terephthalic acid and hexamethylenediamine, isophthalic acid and hexamethylenediamine, adipic acid and 2-methylpentamethylenediamine, terephthalic acid and 2-methylpentamethylenediamine, isophthalic acid and 2-methylpentamethylenediamine, sebacic acid and 1.5-diaminopentane (nylon-5,10), adipic acid and 1.4-diaminobutane (nylon-4,6), sebacic acid and 1,4-diaminobutane (nylon-4,10), terephthalic acid and 1,4-diaminobutane, terephthalic acid and 1,9-diaminononane, terephthalic acid and 1,10-diaminodecane, terephthalic acid and 1,12-diaminododecane, terephthalic acid and trimethylhexamethylenediamine, adipic acid and meta-xylenediamine, sebacic acid and 1,10-diaminodecane (nylon-10,10), dodecanedioic acid and 1,12-diaminododecane (nylon-12,12), or dodecanedioic acid and 4,4′-methylenedi(cyclohexan-1-amine). In some embodiments, the blend of two or more polyamides is composed of any two or more of nylon-6, nylon-6,6, or nylon-12. In some embodiments, the blend of two or more polyamides includes nylon-6 and nylon-6,6. In some embodiments, the blend of two or more polyamides includes nylon-6 and nylon-12. In some embodiments, the blend of two or more polyamides includes nylon-6,6 and nylon-12.

In some embodiments, the polymer substrate is a woven textile, a nonwoven textile, leather, a synthetic leather, or an artificial leather. In some embodiments, the polymer substrate is made by impregnating non-woven or woven textiles made of nylon or polyester with polyurethane resin and then soaking the textiles in water or a solvent mixture to harden them. In some embodiments, the method of solidifying polymer elasticity by wet method includes, for example, immersion in a solidifying solution at 20-60° C. for 1-60 minutes, which contains a good polyurethane solvent such as N,N-dimethylformamide, dimethylacetamide, N-methylpyrrolidone, etc., and water. The method of coagulation includes immersion in a coagulating solution at 20-60° C. for 1-60 minutes. In some embodiments, the polymer substrate is made by laminating a layer of polyurethane resin onto the surface of artificial leather. In some embodiments, the base yarns of non-woven fabrics are composed of ultrafine fibers, for example, with fiber diameters of about 0.1 micrometers (μm) to about 0.5 μm, to about 1 μm, to about 2 μm, to about 4 μm, to about 10 μm, to about 20 μm, or to about 50 μm.

In some embodiments, the polymer substrate includes a combination of synthetic and natural fibers, such as, for example, a cotton—polyester blend or a cotton—nylon blend.

In some embodiments, the polymer substrate is in the form of a fiber. For example, the polymer substrate may be extruded into a fiber, prior to or after addition of the ceramic. In some embodiments, the fiber is knit or woven into a textile. In other embodiments, the fiber is assembled into a nonwoven textile. In some embodiments, the fiber diameter (i.e., number average diameter) ranges from about 10 μm to about 100 μm, from about 50 μm to about 250 μm, from about 100 μm to about 300 μm, from about 300 μm to about 500 μm, or from about 100 μm to about 500 μm. In some embodiments, the mean fiber diameter ranges from about 5 μm to about 20 μm, or from about 2 μm to about 10 μm, or from about 1 μm to about 5 μm. In some embodiments, the mean fiber diameter ranges from about 0.1 μm to about 4 μm. In some embodiments, the mean fiber diameter is less than about 1000 μm, less than about 900 m, less than about 800 μm, less than about 700 μm, less than about 600 μm, less than about 500 μm, less than about 400 μm, less than about 300 μm, less than about 200 μm, less than about 100 μm, less than about 90 μm, less than about 80 μm, less than about 70 μm, less than about 60 μm, less than about 50 m, less than about 40 μm, less than about 30 μm, less than about 20 μm, less than about 10 μm, less than about 5 μm, less than about 2 μm less than about 1 μm, or less than about 0.5 μm.

In some embodiments, the polymer substrate is in the form of a lightweight woven fabric. In some embodiments, the lightweight woven fabric is a ripstop fabric that uses a reinforcing technique that makes it more resistant to tearing and/or ripping. In some embodiments, during weaving, stronger (and often thicker) reinforcement yarns are interwoven at regular intervals in a crosshatch pattern. When lightweight woven fabrics are used as base fabrics, the base fabric may have a density of about 20 g/m² to about 400 g/m², or about 30 g/m² to 150 g/m². In some embodiments, plain weave is preferred for the structure of the base fabric from the viewpoints of denseness and prevention of misalignment of the weave. The weave density of the base cloth can be changed depending on whether the base cloth is resin-processed or not, or on the fineness of the weave yarns, or other design factors. As an example, the density of the woven fabric should be about 120 yarns/2.54 cm, or about 130 to about 300 yarns/2.54 cm for the warp density and about 80 yarns/2.54 cm, or about 90 to about 300 yarns/2.54 cm for the weft density. The total fiber count of the base fabric may be about 20 to about 80 decitex (dtex), or about 25 to about 70 dtex. The cover factor (CF) may be about 800 to about 5500, or about 1000 to about 5000. The cover factor is the value obtained from the total fiber count and the beating density of the yarn used in the warp or weft, which is defined by Equation (1). In Equation (1), De is the total warp fiber count (dtex), D_{f} is the total weft fiber count (dtex), N_{w} is the warp weave density (yarns/2.54 cm), N_{f} is the weft weave density (yarns/2.54 cm)

$$CF = {N}_{w} sqrt ( {D}_{w} ) + {N}_{f} sqrt ( {D}_{f} ) \qquad ( Eq . 1 )$$

In some embodiments the polymer substrate is in the form of a film. For example, the polymer substrate may be formed into a film, prior to or after addition of the ceramic. In some embodiments, the film has an average thickness of less than about 5 millimeters (mm), less than about 4 mm, less than about 3 mm, less than about 2 mm, or less than about 1 mm. In some embodiments, the film has an average thickness of from about 10 μm to about 100 μm, from about 10 μm to about 500 μm, from about 100 μm to about 500 μm, from about 500 μm to about 1000 μm, or from about 1000 μm to about 5000 μm.

In some embodiments the polymer substrate is formed into a structural element, cast into a shape, printed or otherwise deposited from a melt and nozzle arrangement, or photocured from a melt to form a complex structure, prior to or after addition of the ceramic material to form a polymer-ceramic composite.

In some embodiments the polymer substrate is chemically altered, such as by a cross-linking reaction, with different parts of the polymer chain, or a functional group on the polymer chain is reacted with one or more chemical substance to form a different polymer, such as the formation of vinylon from polyvinyl alcohol. In some embodiments, the polymer substrate is chemically altered prior to or after the addition of the ceramic material to form a polymer-ceramic composite.

In some embodiments, the polymer substrate is formed by a spinning method, for example a wet cooled-gel spinning method where a resin is dissolved in solvent, extruded into a second solvent forming a resin-gel, and the second solvent is removed to form a fiber. In some embodiments, the resin is polyvinyl alcohol (PVOH). In some embodiments, the polymer substrates are water soluble fibers. In some embodiments, the water soluble fibers have dissolving temperatures of about 20° C. to about 95° C., about 20° C. to about 60° C., about 30° C. to about 70° C., about 40° C. to about 80° C., about 50° C. to about 95° C., about 20° C. to about 45° C., about 30° C. to about 80° C., about 20° C., about 40° C., about 60° C., about 70° C., about 80° C., or about 95° C. In some embodiments, the water soluble fibers are staple fibers with a fineness of about 1 dtex to about 3 dtex, about 1.4 dtex, about 1.7 dtex, or about 2.2 dtex. In some embodiments, the water soluble fibers are spun yarns with a yarn count of about 20:1 English cotton count (ECC) to about 80:1 ECC, about 20:1 ECC, about 30:1 ECC, about 40:1 ECC, about 50:1 ECC, about 80:1 ECC, where ECC is the number of 840 yard lengths per pound. In some embodiments, the polymer substrate are fibers drawn to obtain high-tenacity fibers. In some embodiments, the polymer substrate is a high tenacity material formed into short cut fibers, staple fibers, or spun yarns. In some embodiments, the polymer substrate is a short cut fiber with a tenacity of about 5 cN/dtex to about 20 cN/dtex, about 5 cN/dtex to about 10 cN/dtex, about 10 cN/dtex to about 15 cN/dtex, about 15 cN/dtex to about 20 cN/dtex, about 5 cN/dtex to about 20 cN/dtex, about 10 cN/dtex to about 20 cN/dtex, about 9 cN/dtex, about 10cN/dtex, about 12 cN/dtex, or about 15cN/dtex. In some embodiments, the polymer substrate is a staple fiber with a tenacity of about 10cN/dtex, a modulus between about 75 cN/dtex and about 150 cN/dtex, and a density of about 1 dtex to about 3 dtex, about 1.3 dtex, about 1.7 dtex, or about 2.2 dtex. In some embodiments, the polymer substrate are spun yarns with an elongation of less than any of about 10%, about 6%, about 7%, about 8% or about 9%, and a yarn count of about 5:1 English cotton count (ECC) to about 80:1 ECC, about 5:1 ECC, about 10:1 ECC, about 20:1 ECC, about 30:1 ECC, about 60:1 ECC, or about 80:1 ECC where ECC is the number of 840 yard lengths per pound.

In some embodiments, the polymer substrate is a polymer film with an adhesive layer. In some embodiments, the polymer substrate is a matte cellulose acetate film of about 10 μm to about 200 μm in thickness, about 20 μm to about 100 μm in thickness, about 30 μm to about 50 μm, about 40 μm to about 100 μm in thickness, or about 40 μm in thickness, with a synthetic acrylic adhesive layer. In some embodiments, the polymer substrate is a conductive polycarbonate of about 10 μm to about 500 μm in thickness, about 50 μm to about 100 μm, about 75 μm to about 150 μm, about 100 μm to about 200 μm, about 150 μm to about 150 μm, about 50 μm in thickness, about 100 μm in thickness, or about 200 μm in thickness, with a carbon-filled acrylic adhesive layer.

In some embodiments a polymer melt is formed by heating the polymer to a temperature above its melting point or by dissolving the polymer in a suitable solvent. The melt can then be extruded to form a filament or fibers, or cast into a shape or film, or printed or otherwise deposited to form a melt and nozzle arrangement forming a polymer substrate. These steps can be completed prior to or after the addition of the ceramic material to form a polymer-ceramic composite.

### Ceramic

In some embodiments, the ceramic deposited onto the polymer substrate as described herein includes a transition metal oxide, a transition metal carbonate, a transition metal oxalate, a transition metal phosphate, a transition metal sulfate, or combinations thereof. In some embodiments, the ceramic includes an alkali metal oxide, an alkaline earth oxide, an alkali carbonate, an alkaline earth carbonate, an alkali oxalate, an alkaline earth oxalate, an alkali phosphate, an alkaline earth phosphate, an alkali sulfate, an alkaline earth sulfate, or combinations thereof. In some embodiments, the ceramic includes a metal oxide, a metal hydroxide, a layered double hydroxide, a metal carbonate, a metal oxalate, a metal phosphate, a metal sulfate, or mixtures thereof, wherein the metal is a transition metal, an alkali metal, or an alkaline earth metal. In some embodiments, the ceramic includes a metal oxide, a metal hydroxide, a layered double hydroxide, a metal carbonate, a metal oxalate, a metal phosphate, a metal sulfate, or mixtures thereof, wherein the metal is aluminum, silicon, or tin. In some embodiments, the ceramic includes a transition metal, an alkali metal, an alkaline earth metal, aluminum, silicon, or tin. In some embodiments, the ceramic includes magnesium, calcium, titanium, manganese, iron, zinc, zirconium, tungsten, nickel, cobalt, or mixtures thereof. In some embodiments, the ceramic includes oxygen, phosphorus, sulfur, carbon, or mixtures thereof. In some embodiments, the ceramic includes manganese oxide, zinc oxide, silicon oxide, aluminum oxide, titanium dioxide, iron oxide, cobalt oxide, nickel oxide, zirconium oxide, or mixtures thereof. In some embodiments, the ceramic includes hydroxyapatite, calcium carbonate, magnesium carbonate, calcium sulfate, cerium oxide, octacalcium phosphate, calcium phosphate, or mixtures or hydrates thereof. In some embodiments, wherein the ceramic includes phosphate, the phosphate is present in partially protonated, partially hydrated, hydrated, partially dehydrated forms, or dehydrated forms. In some embodiments, wherein the ceramic includes calcium phosphate, the calcium phosphate includes hydroxyapatite [Ca₅(PO₄)₃OH], brushite [Ca(PO₃OH)*₂H₂O], monetite [Ca(PO₃OH)], or mixtures thereof. In some embodiments, wherein the ceramic includes sulfate, the sulfate is present in partially protonated, partially hydrated, or partially dehydrated forms.

In some embodiments, additional inorganic elements, inorganic compounds, and/or ionic compounds may also penetrate the ceramic deposited onto the polymer substrate as well as the polymer matrix internal volume. In some embodiments, the inorganic elements, compounds and/or ionic compounds are contained within an amorphous, inorganic glass phase. In some embodiments, the inorganic elements, compounds and/or ionic compounds are contained within a crystalline, or multi-crystalline domain or phase. In some embodiments, the inorganic elements, compounds and/or ionic compounds are contained within a crystalline domain in an ordered manner. In some embodiments, the inorganic elements, compounds and/or ionic compounds are distributed or contained along crystalline domain boundaries, grain boundaries, defects, or pores. In some embodiments, the inorganic elements, compounds and/or ionic compounds are distributed along the polymer matrix exterior surface. In some embodiments, the inorganic elements, compounds and/or ionic compounds are distributed into the polymer substrate interior volume. In some embodiments, the inorganic elements, compounds and/or ionic compounds are distributed among the ceramic deposited onto the polymer substrate, along the polymer substrate exterior surface, within the polymer substrate interior volume, or combinations thereof.

In some embodiments, complementary inorganic elements also penetrate the ceramic deposited onto the polymer substrate as well as the polymer matrix internal volume. In some embodiments, the complementary inorganic elements are contained within an amorphous, inorganic glass phase. In some embodiments, the complementary inorganic elements are contained within a crystalline, or multi-crystalline domain or phase. In some embodiments, the complementary inorganic elements are contained within a crystalline domain in an ordered manner. In some embodiments, the complementary inorganic elements are distributed or contained along crystalline domain boundaries, grain boundaries, defects, or pores. In some embodiments, the complementary inorganic elements are distributed along the polymer matrix exterior surface. In some embodiments, the complementary inorganic elements are distributed into the polymer substrate interior volume. In some embodiments, the complementary inorganic elements are distributed among the ceramic deposited onto the polymer substrate, along the polymer substrate exterior surface, within the polymer substrate interior volume, or combinations thereof.

In some embodiments, the complementary inorganic element includes potassium, magnesium, chlorine, bromine, iodine, phosphorus, sulfur, nitrogen, oxygen, carbon, hydrogen, manganese, aluminum, titanium, sodium, calcium, or a combination thereof. In some embodiments, the complementary inorganic element is present as a counterion, present in a counterion, or present as a component of a counterion. In some embodiments, the counterion is a cation or an anion. In some embodiments, the counterion is a cation. In some embodiments, the complementary inorganic element is present in a potassium cation, a magnesium cation, a manganese cation, an aluminum cation, a titanium cation, a sodium cation, a calcium cation, an ammonium cation, or a combination thereof. In some embodiments, the complementary inorganic element is present in a cation comprising potassium, magnesium, manganese, aluminum, titanium, sodium, calcium, nitrogen, or a combination thereof. In some embodiments, the complementary inorganic element is present as K⁺¹, Mg⁺² Mn⁺², Mn⁺³, Mn⁺⁵, Mn⁺⁷, Al⁺³, Ti⁺⁴, Na⁺¹, Ca⁺², NH₄⁺¹, or a combination thereof. In some embodiments, the cation is hydrated. In some embodiments, the hydrated cation is partially dehydrated. In some embodiments, the hydrated cation is partially deprotonated. In some embodiments, the hydrated cation is partially deprotonated, and the degree of deprotonation is dependent on the effective pH of the immediate environment of the hydrated cation. In some embodiments, the counterion is an anion. In some embodiments, the complementary inorganic element is nitrogen and present in nitrate (NO₃⁻¹), nitrite (NO₂⁻¹), nitride (N⁻³), amide (NH₂⁻¹), or a combination thereof. In some embodiments, the complementary inorganic element is oxygen and present in hydroxide (OH⁻¹), oxide (O⁻²), peroxide (O₂⁻²), hydroperoxide (HO₂⁻¹), or a combination thereof. In some embodiments, the complementary inorganic element is chlorine and present in chloride (Cl⁻¹), perchlorate (ClO₄⁻¹), chlorate (ClO₃⁻¹), chlorite (ClO₂⁻¹), hypochlorite (ClO⁻¹), or a combination thereof. In some embodiments, the complementary inorganic element is bromine and present in bromide (Br⁻¹), perbromate (BrO₄⁻¹), bromate (BrO₃⁻¹), bromite (BrO₂⁻¹), hypobromite (BrO⁻¹), or a combination thereof. In some embodiments, the complementary inorganic element is iodine and present in iodide (I⁻¹), periodate (IO₄⁻¹), iodate (IO₃⁻¹), iodite (IO₂⁻¹), hypoiodite (IO⁻¹), or a combination thereof. In some embodiments, the complementary inorganic element is phosphorus and present in phosphate (PO₄⁻³), hydrogen phosphate (HPO₄⁻²), dihydrogen phosphate (H₂PO₄⁻¹), or a combination thereof. In some embodiments, the complementary inorganic element is sulfur and present in sulfate (SO₄⁻²), hydrogen sulfate (HSO₄⁻¹), sulfite (SO₃⁻²), hydrogen sulfite (HSO₃⁻¹), sulfide (S-2), thiosulfate (S₂O₃⁻²), thiocyanate (SCN⁻¹) or a combination thereof. In some embodiments, the complementary inorganic element is carbon or nitrogen and present in cyanate (OCN⁻¹), thiocyanate (SCN⁻¹), or a combination thereof. In some embodiments the anion is permanganate (MnO₄⁻¹) or hydride (H⁻¹). In some embodiments the anion is permanganate (MnO₄⁻¹). In some embodiments, the complementary inorganic element is carbon and present in carbonate (CO₃⁻²), hydrogen carbonate (HCO₃⁻¹), or a combination thereof. In some embodiments, the complementary inorganic element is carbon and present in a carboxylate anion. In some embodiments, the carboxylate anion is formate, acetate, propionate, butyrate, iso-butyrate, or a combination thereof. In some embodiments, the complementary inorganic element is carbon and present in a dicarboxylate anion. In some embodiments, the dicarboxylate anion is succinate, malonate, oxalate, or a combination thereof. In some embodiments the dicarboxylate anion is partially protonated. In some embodiments the dicarboxylate anion is partially protonated, and the degree of deprotonation is dependent on the effective pH of the immediate environment of the dicarboxylate anion. In some embodiments, the complementary inorganic element is present in an anion comprising chlorine, bromine, iodine, phosphorus, sulfur, nitrogen, oxygen, carbon, hydrogen, manganese, or a combination thereof.

In some embodiments, the ceramic precursors include calcium nitrate and potassium phosphate, the counterions include nitrate and potassium, and the complementary inorganic elements include nitrogen, oxygen, and/or potassium. In some embodiments, the ceramic precursors calcium nitrate and potassium phosphate, the counterions include nitrate and potassium, the complementary inorganic elements include nitrogen, oxygen, and/or potassium, and nitrogen, oxygen, potassium, or a combination thereof penetrate the ceramic and/or the polymer matrix internal volume.

In some embodiments, the ceramic precursors include calcium nitrate and sodium oxalate dihydrate, the counterions include nitrate and sodium, and the complementary inorganic elements include nitrogen, oxygen, and/or sodium. In some embodiments, the ceramic precursors include calcium nitrate and sodium oxalate dihydrate, the counterions include nitrate and sodium, the complementary inorganic elements include nitrogen, oxygen, and/or sodium, and nitrogen, oxygen, sodium, or a combination thereof penetrate the ceramic and/or the polymer matrix internal volume.

In some embodiments, the ceramic precursors include calcium nitrate and/or calcium chloride and ammonium hydrogen phosphate, ammonium dihydrogen phosphate, potassium hydrogen phosphate, potassium dihydrogen phosphate, sodium hydrogen phosphate, and/or sodium dihydrogen phosphate, the counterions include nitrate and/or chloride and ammonium, potassium, and/or sodium, and the complementary inorganic elements include nitrogen, chlorine, oxygen, potassium and/or sodium. In some embodiments, the ceramic precursors include calcium nitrate and/or calcium chloride and ammonium hydrogen phosphate, ammonium dihydrogen phosphate, potassium hydrogen phosphate, potassium dihydrogen phosphate, sodium hydrogen phosphate, and/or sodium dihydrogen phosphate, the counterions include nitrate and/or chloride and ammonium, potassium, and/or sodium, the complementary inorganic elements include nitrogen, chlorine, oxygen, potassium and/or sodium, and nitrogen, chlorine, oxygen, potassium, sodium, or a combination thereof penetrate the ceramic and/or the polymer matrix internal volume.

In some embodiments, the ceramic precursors include manganese nitrate and sodium hydroxide, the counterions include nitrate and sodium, and the complementary inorganic elements include nitrogen, oxygen, and/or sodium. In some embodiments, the ceramic precursors include manganese nitrate and sodium hydroxide, the counterions include nitrate and sodium, the complementary inorganic elements include nitrogen, oxygen, and/or sodium, and nitrogen, oxygen, sodium, or a combination thereof penetrate the ceramic and/or the polymer matrix internal volume.

In some embodiments, the ceramic precursors include manganese sulfate and potassium persulfate and/or ammonium hydroxide, the counterions include sulfate and ammonium and/or potassium, and the complementary inorganic elements include sulfur, oxygen, nitrogen, and/or potassium. In some embodiments, the ceramic precursors include manganese sulfate and potassium persulfate and/or ammonium hydroxide, the counterions include sulfate and ammonium and/or potassium, the complementary inorganic elements include sulfur, oxygen, nitrogen, and/or potassium, and nitrogen, oxygen, sodium, or a combination thereof penetrate the ceramic and/or the polymer matrix internal volume.

The ceramic that is deposited onto the polymer substrate may be in the form of discrete particulates or smaller aggregates. In some embodiments, the size of the discrete particulates or smaller aggregates, i.e., the average particle size of the ceramic (e.g., mean diameter), is from about 0.05 μm to about 5 μm, from about 0.5 μm to about 10 μm, or from about 0.1 μm to about 0.5 μm. In some embodiments, the average particle size is less than about 10 μm, less than about 5 μm, less than about 1 m, less than about 0.5 μm, less than about 0.1 m, or less than about 0.05 μm. In some embodiments, the ceramic deposited onto the polymer may be in the form of networked particulates, agglomerations or aggregates. In some embodiments, the ceramic may be nanostructured and have geometrically similar features or structures such as plates, rods, spheroids or agglomerates which have at least one dimension that is less than about 100 nm.

In some embodiments, the ceramic that is deposited onto the polymer substrate has an average thickness of from about 0.05 μm to about 5 μm, or from about 0.05 μm to about 10 μm, or from about 0.1 μm to about 0.5 μm, or less than about 10 μm, or less than about 5 μm, or less than about 1 μm, or less than about 0.5 μm, or less than about 0.25 μm, or less than about 0.2 μm, or less than about 0.15 μm, or less than about 0.1 μm, or less than about 0.075 μm, or less than about 0.05 μm outside of the polymer layer, i.e., as measured from the external surface of the polymer substrate. The mean thickness of the ceramic is the distance from the external surface of the polymer substrate to the external surface of the ceramic.

In some embodiments, the ceramic that is deposited onto the polymer substrate has a secondary structure in the form of plates or platelike morphology on the outer surface of the ceramic.

In some embodiments, the ceramic is crystalline. In other embodiments the ceramic is amorphous. In some embodiments, the ceramic contains an aggregate of crystalline domains.

### Polymer-Ceramic Composite

In one aspect, a polymer-ceramic composite is provided. The polymer-ceramic composite includes: a polymer substrate, which includes a polymer matrix that has an external surface and an internal volume; and a ceramic.

In some embodiments, the polymer-ceramic composite includes ceramic on the external surface of the polymer matrix and the ceramic or inorganic elements at least partially occupies the internal volume of the polymer matrix, i.e., occupies at least a portion of the polymer matrix interior volume.

In some embodiments, the polymer-ceramic composite is in the form of a fiber or a film. In some embodiments, the polymer-ceramic composite is in the form of a fiber with a mean diameter less than about 5 millimeters or less than about 1 millimeter. In some embodiments, the polymer-ceramic composite is in the form of a film with a mean thickness less than about 5 millimeters or less than about 3 millimeters.

In some embodiments, the polymer-ceramic composite is in a core and shell configuration, i.e., a polymer core and a shell that includes the ceramic. In the core and shell configuration, the polymer substrate, which includes a polymer matrix that has an external surface and an internal volume, is the core; and the ceramic, which includes ceramic on the external surface of the polymer matrix and ceramic or inorganic elements at least partially occupying the internal volume of the polymer matrix, is the shell. In some embodiments where the polymer-ceramic composite is present in a core and shell configuration, the polymer substrate is in the form of a fiber. In some embodiments where the polymer-ceramic composite is present in a core and shell configuration, the polymer substrate is in the form of a fiber and the fiber cross section is circular, nearly circular, or elliptical in cross section. In some embodiments where the polymer-ceramic composite is present in a core and shell configuration, the polymer substrate is in the form of a fiber and the fiber cross section is semi-circular, or nearly semicircular in cross section. In some embodiments where the polymer-ceramic composite is present in a core and shell configuration, the polymer substrate is in the form of a fiber and the fiber cross section is triangular, Reuleaux triangular or nearly triangular, or square, or nearly square, or polygonal in cross section. In some embodiments where the polymer-ceramic composite is present in a core and shell configuration, the polymer substrate is in the form of a fiber and the fiber cross section is epicycloidal, hypocycloidal, lobal, trilobal, pentalobal, octalobal, multilobal, oval, flat, dog bone, or star-shaped, in cross section.

In some embodiments, the polymer-ceramic composite includes a core and a shell, wherein the core includes a polymer and the shell includes a ceramic. In some embodiments, the core includes a relative polymer weight percentage greater than about 50%, greater than about 60%, greater than about 70%, greater than about 80%, greater than about 90%, or greater than about 95%. In some embodiments, the shell includes a relative ceramic weight percentage greater than about 10%, greater than about 20%, greater than about 30%, greater than about 40%, greater than about 50%, greater than about 60%, greater than about 70%, or greater than about 80%. In some embodiments, the core and the shell have a discrete boundary therebetween. In some embodiments, the core and the shell include the same or similar chemical components or materials in different ratios. In some embodiments, the core and the shell have a boundary that includes a spatial gradient in concentration of chemical components or materials in the core, a spatial gradient in concentration of chemical components or materials in the shell, or a spatial gradient in concentration of chemical components or materials in both the core and the shell. In some embodiments, the core and the shell include different chemical components or materials. In some embodiments, the core and the shell both include the same chemical components or materials, but with different properties such as density, molecular weight, or degree of crosslinking.

In some embodiments, the polymer-ceramic composite is in a film and coating configuration wherein the polymer substrate, which includes a polymer matrix that has an external surface and an internal volume, is the film; and the ceramic, which includes ceramic on the external surface of the polymer matrix and ceramic or inorganic elements at least partially occupying the internal volume of the polymer matrix, is the coating applied to one or more external surfaces.

In some embodiments of the film, the ceramic concentration on one side of the film external surface is higher than on the opposite side of the film external surface.

In some embodiments, the polymer-ceramic composite is in the form of a laminate, and the ceramic concentration relative to the polymer matrix increases in the outermost layers of the laminate relative to inner layers. In a laminate, containing a plurality of layers that are fixed or adhered together, the topmost and bottommost layers of the laminate serve as the polymer substrate for preparation of a polymer-ceramic composite as described herein. Each of the topmost and bottommost layers of the laminate structure contains an external surface and a polymer matrix internal volume, a first portion of the ceramic on each of the external surfaces of the topmost and the bottommost layers, and a second portion of the ceramic in each of the polymer matrix internal volumes of the topmost and the bottommost layers of the laminate.

In some embodiments, the polymer-ceramic composite is a textile material that includes a polyamide, a polyester, a polyolefin, a substituted polyolefin, a polyurethane, a polyol, a vinyl group, a polyether, cotton, wool, a cellulosic material, or a combination thereof.

In some embodiments, the polymer-ceramic composite includes a thermoplastic core material. Nonlimiting examples of the thermoplastic core material include a polyester, a polyamide, a polyurethane, an acrylic (poly acrylate), a polyolefin, a polyol, acrylonitrile butadiene styrene (ABS), a polyvinyl alcohol, or a combination thereof.

In some embodiments, the polymer-ceramic composite has a core material that includes a cotton, wool, or cellulosic material, a blends of natural and synthetic fibers, or a combination thereof.

In some embodiments, the polymer-ceramic composite as described herein includes a gradient of ceramic from the center of the polymer substrate, i.e., from the centerline of a polymer fiber, such as in the case of a woven or non-woven textile, from the centerline of the polymer substrate in the case of a film or sheet, and from a distance of 2 millimeter from the surface of a thicker cast or molded part. In some embodiments, the relative proportion of ceramic increases from the center of the polymer substrate (e.g., polymer fiber or film) to the surface of the polymer substrate. In some embodiments, the highest proportion of the ceramic is outside of the polymer substrate. In some embodiments, ceramic particles are embedded in the interior volume of the polymer substrate and simultaneously protrude through the surface of the polymer substrate (e.g., polymer fiber or film).

In some embodiments, greater than about 10%, or greater than about 20%, or greater than about 30%, or greater than about 40%, or greater than about 50%, or greater than about 60%, or greater than about 70%, or greater than about 80%, or greater than about 90% of total ceramic in the polymer-ceramic composite protrudes through the polymer substrate surface.

In some embodiments, the ceramic in the polymer-ceramic composite is nanostructured and includes structures or features such as plates, rods, spheroids or agglomerates, which are geometrically similar and which have at least one dimension that is less than 100 nanometers.

In some embodiments, the polymer-ceramic composite is coated with one or more functional molecules to impart one or more desired properties. In some embodiments, the polymer-ceramic composite is functionalized with a thin film which has a thickness of less than about 1 μm, or less than about 500 nanometers (nm), or less than about 200 nm, or less than about 150 nm, or less than about 100 nm, or less than about 50 nm, or less than about 20 nm, or less than about 10 nm. In some embodiments, the polymer-ceramic composite is coated with a monolayer chemistry where a film conformally coats the polymer-ceramic with a characteristic thickness of less than about 5 nm. In some embodiments, the polymer-ceramic composite is coated with a functional layer. In certain embodiments, the functional layer includes a monolayer chemistry, i.e., the functional layer is substantially a monolayer of functional molecules. The monolayer may have a thickness less than about 5 nm. In some embodiments, the polymer-ceramic composite is coated with a silane, a siloxane, a urethane, an acrylate, or with a molecule with a head group and a tail group (for example, wherein the head group includes a silane group, a phosphonate group, a phosphonic acid group, a carboxylic acid group, a vinyl group, an alcohol group, a hydroxide group, a thiolate group, a thiol group, and/or an ammonium group (e.g., a quaternary ammonium group), and wherein the tail group includes a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group.

In some embodiments, the polymer-ceramic composite contains a polymer core and a shell that includes a ceramic. In some embodiments, the ceramic shell of the polymer-ceramic composite material has a thickness less than 20% of the hydraulic diameter of the polymer core. In some embodiments, the ceramic containing shell of the polymer-ceramic composite material has a thickness less than about 1 micrometer. In some embodiments, the polymer core has a diameter or thickness greater than about 1 micrometer. In some embodiments, the polymer core includes a thermoplastic, such as a polyester, a polyamide, a polyurethane, an acrylic (polyacrylate), a polyolefin, a polyol, ABS, a polyvinyl alcohol, or a combination thereof. In some embodiments, the polymer core includes cotton, wool, or cellulosic material. In some embodiments, the polymer-ceramic composite material has a cylindrical polymer core and a ceramic shell. In some embodiments, the ceramic containing shell includes a transition metal, an alkali metal, or an alkaline earth metal. In some embodiments, the transition metal or alkaline earth metal is iron, magnesium, zinc, manganese, calcium, or nickel. In some embodiments, the transition metal, alkali metal, or alkaline earth metal is in the form of an oxide, a hydroxide, a phosphate, a carbonate, a sulfate, or a combination thereof. In some embodiments, the phosphate, carbonate, sulfate, or combination thereof is present in varying degree of protonation or deprotonation. In some embodiments, a carbonate is present as carbonate or bicarbonate, or a combination thereof. In some embodiments the phosphate is present as hydrogen phosphate (HPO₄²⁻), dihydrogen phosphate (H₂PO₄¹⁻), phosphate (PO₄³⁻), or a combination thereof. In some embodiments, a sulfate is present as sulfate, bisulfate, or a combination thereof. In some embodiments, the ceramic weight fraction in the shell is less than about 0.9. In some embodiments, the ceramic in the shell has a morphology with at least one dimension less than 100 nanometers. In some embodiments, the ceramic in the shell has a morphology of 0-dimensional, 1-dimensional or 2-dimensional materials. In some embodiments, the ceramic containing shell includes a siloxane, an acrylate, a phosphonate, a sulfonate, a urethane, or a combination thereof. In some embodiments, the shell includes a silicone polymer or an alkyl terminated silane or siloxane. In some embodiments, the shell includes an alkyl terminated functional group. In some embodiments, the alkyl terminated functional group includes a saturated chain length longer than three carbons. In some embodiments, the shell includes an isocyanate or an isocyanate terminated polymer. In some embodiments, the shell is adhered to the core. In some embodiments, the adhesion between the shell and the core is rated from 0 to 5 according to a standard method such as ASTM D3359 and the adhesion rating is increased in the core-shell configuration as compared to the initial textile. In some embodiments, textile test methods such as the single fiber pull out test or the fiber matrix adhesion tester (FIMATEST) are used to measure changes in fiber adhesion to the textile as an indicator of core-shell adhesion. In some embodiments, textile tear strength methods such as ASTM D1424 or ASTM D5034 are used to measure changes in tear strength as an indicator of core-shell adhesion.

In some embodiments, the polymer-ceramic composite has a surface roughness greater than 1.1. In some embodiments, at least a portion of the ceramic in the shell is interconnected. In some embodiments, the polymer-ceramic composite includes a polymer film or polymer film layer of a laminate and a deposition comprising a ceramic on at least one side of the film. In some embodiments, the deposited ceramic has a thickness less than 20% of the mean thickness of the polymer film. In some embodiments, the deposited ceramic has a thickness less than about 1 micrometer. In some embodiments, the polymer film substrate has a thickness greater than about 1 micrometer. In some embodiments, the polymer film substrate contains a thermoplastic. In nonlimiting examples, the thermoplastic is a polyester, a polyamide, a polyurethane, an acrylic (acrylate polymer), a polyolefin, a polyol, ABS, a polyvinyl alcohol, or a combination thereof. In some embodiments, the polymer film substrate contains cellulosic material, or cellulosic derived material. In some embodiments, the deposited ceramic includes a transition metal or an alkaline earth metal. In some embodiments, the transition metal or alkaline earth metal is iron, magnesium, zinc, manganese, calcium, or nickel. In some embodiments, the transition metal or alkaline earth metal is in the form of an oxide, a hydroxide, a phosphate, a carbonate, a sulfate, or a combination thereof. In some embodiments, the ceramic fraction in the deposited ceramic is less than about 0.9. In some embodiments, the deposited ceramic includes morphologies with at least one dimension less than 100 nanometers. In some embodiments, the deposited ceramic includes 0-dimensional or 2-dimensional morphology. In some embodiments, the deposited ceramic includes a siloxane, an acrylate, a phosphonate, a sulfonate, a urethane, or combination thereof. In some embodiments, the deposited ceramic includes a silicone polymer or an alkyl terminated silane or siloxane. In some embodiments, the deposited ceramic includes an alkyl terminated functional group. In some embodiments, the alkyl terminated functional group includes a saturated chain length longer than three carbons. In some embodiments, deposited ceramic includes an isocyanate or isocyanate terminated polymer. In some embodiments, the deposited ceramic is chemically bound to the polymer film material. In some embodiments, the polymer-ceramic composite material has a surface roughness greater than 1.1. In some embodiments, at least a portion of the deposited ceramic is interconnected. In some embodiments, greater than about 50% of the ceramic on a particle basis is interconnected. In some embodiments, greater than about 20%, or greater than about 30%, or greater than about 40%, or greater than about 60%, or greater than about 70%, or greater than about 80%, or greater than about 90% of the ceramic on a particle basis is interconnected.

In some embodiments, the ceramic includes crystalline domains. In some embodiments, the ceramic includes crystalline particles. In some embodiments, the crystalline domains or crystalline particles are embedded in an amorphous matrix. In some embodiments, the amorphous matrix includes at least one element that is included in the crystalline particles or crystalline domains. In some embodiments, the amorphous matrix includes two or more common elements with the crystalline particles or crystalline domains. In some embodiments, the crystalline domains range in size from about 2 nm in nominal dimension to about 200 nm in nominal dimension. In some embodiments, substrates are sequentially contacted with liquid solutions by spraying, padding, or immersion. In these cases, a first solution in contact with the substrates is considered the first contact solution, a second solution in contact with the substrate after the first solution, is considered the second contact solution, and so on. In some embodiments, the crystalline domains or crystalline particles include metal(s) from metal salt(s) in the first and/or second contact solutions. In some embodiments, the crystalline domains or crystalline particles include a rare earth metal, a transition metal, an alkaline earth metal, or a combination thereof. In some embodiments, the ceramic contains crystalline domains which include Ca, Zn, Ni, Li, Mg, Ti, Mn, or a combination thereof. In some embodiments, the ceramic contains crystalline domains which include phosphate, carbonate, or sulfate groups. In some embodiments, the phosphate is polyphosphate, pyrophosphate, hydrogen phosphate, dihydrogen phosphate, or orthophosphate. In some embodiments, the amorphous matrix contains calcium, phosphorus, and or oxygen. In some embodiments, the ceramic contains crystalline domains or crystalline particles that contain octacalcium phosphate, hydroxyapatite, monetite, brushite, calcium triphosphate, calcium pyrophosphate, and/or hydrates thereof.

In some embodiments, the polymer-ceramic composite is an assembly of a plurality of polymer-ceramic composites, such as a plurality of fibers that are formed into the assembly. In some embodiments, polymer-ceramic composite fibers are assembled into yarns, woven textiles, knit textiles, or non-woven textile materials.

In some embodiments, the polymer-ceramic composite is functionalized, i.e., the ceramic, the polymer substrate, or both are functionalized, i.e., modified with one or more functional group or molecule to impart one or more desirable property. In some embodiments, the functionalized polymer-ceramic composite increases the hydrophobicity of the substrate compared to the unfunctionalized polymer-ceramic composite. In some embodiments the functionalized ceramic provides improved properties such as microbial resistance, ultraviolet light resistance, improved chemical resistance, improved tear strength, improved moisture vapor transmission rate (MVTR), light transmission, improved oil or stain resistance, improved wear durability, or improved wash durability. In some embodiments, the polymer-ceramic composite improves these properties when compared to either the polymer substrate and functional layer or the ceramic and functional layer.

In some embodiments, the polymer-ceramic composite has a roughness value Ra of greater than about 0.025 μm, corresponding to an DIN ISO 1302 or DIN 4768 roughness grade number (N) of about N1 and greater, or about N1 to about N8, or about N5 or lower, or any of about or at least about N1 (0.025 μm), N2 (0.5 μm), N3 (0.1 μm), N4 (0.2 μm), N5 (0.4 μm), N6 (0.8 μm), N7 (1.6 μm), or N8 (3.2 μm).

In some embodiments, a polymer-ceramic composite as described herein has a tear strength, tensile strength, gas permeability, vapor permeability, and/or abrasion resistance that is improved relative to an identical polymer substrate without the ceramic and/or an identical polymer-ceramic composite without a functional coating as described herein. In some embodiments, the polymer-ceramic composite is measured in accordance with test standard ASTM D1424 wherein the tear strength is greater than about than about 5000gF, or greater than about 2000gF, or greater than about 1000gF or greater than about 500gF or about 100gF greater than the uncoated material. In some embodiments, the polymer-ceramic composite is measured in accordance with test standard ASTM D5034 wherein the breaking strength in gramForce (gF) or gF per width of fabric, elongation is measured and is about 1%, about 2%, about 5%, about 10%, about 25%, about 50%, about 100%, and about 250%, or more. Tensile strength may be determined and is typically reported in MPa. In some embodiments, the polymer-ceramic composite gas permeability is measured in accordance with test standard ASTM D1434. In some embodiments, the polymer-ceramic composite is measured in accordance with test standard ASTM E96 wherein the moisture vapor transport rate (MVTR) is measured and is reported in grams per area per time. In some embodiments, the MVTR is less than about 500 g/day/m², about 500 g/day/m² to about 1000 g/day/m², about 1000 g/day/m² to about 2500 g/day/m², about 2500 g/day/m² to about 5000 g/day/m², about 5000 g/day/m² to about 10000 g/day/m², or greater than about 10000 g/day/m². In some embodiments, the polymer-ceramic composite is measured in accordance with test standard ASTM D4966 wherein the abrasion resistance is measured and is reported according to the ratings outlined in the standard for about 500 cycles, about 1000 cycles, about 5000 cycles, about 10000 cycles, about 30000 cycles, about 50000 cycles, or more.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the second portion of the ceramic has a diffusion length more than about 10 nm, more than about 50 nm, or more than about 100 nm from the external surface into the polymer matrix internal volume at a temperature less than about 160° C. and in a time period of less than about 90 minutes.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the second portion of the ceramic penetrates less than about 90%, less than about 75% less than about 50% less than about 40% less than about 30% less than about 20%, less than about 10%, or less than about 5% of the hydraulic diameter of the polymer matrix, from the external surface into the polymer matrix internal volume.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the ceramic concentration decreases when measured from the external surface of the polymer substrate into the polymer matrix internal volume, or wherein the ceramic concentration decreases at a decreasing rate from the external surface of the polymer substrate into the polymer matrix internal volume, or wherein the ceramic concentration decreases as an exponential decay with an exponential decay constant that is greater than about 0.01 from the external surface of the polymer substrate into the polymer matrix internal volume. The exponential decay is defined by Equation 2, where [C] is the atomic mole percentage, X is the exponential decay constant, and x is the distance into the substrate.

$$[ C ( x ) ] = [ {C}_{o} ] {e}^{- λ x} \qquad ( Eq . 2 )$$

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the second portion of the ceramic contains at least about 1% of the mass of the ceramic and/or the first portion of the ceramic contains less than about 99% of the mass of the ceramic.

In some embodiments, a polymer-ceramic composite as described herein includes a polymer substrate and a ceramic, wherein the polymer substrate has an external surface and a polymer matrix internal volume, a first portion of the ceramic is on the external surface, and wherein at least a portion of the polymer-ceramic composite has a rugosity ratio greater than about 1.1, greater than about 1.2, greater than about 1.3, greater than about 1.5, greater than about 1.75, greater than about 2, greater than about 2.5, greater than about 3, greater than about 5, greater than about 10, greater than about 20, greater than about 50, or greater than about 100.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the second portion of the ceramic includes a metal and wherein the atomic mole percentage of the metal inside the polymer matrix internal volume about 10 nm into the polymer matrix internal volume from the polymer substrate external surface is greater than about 0.1%, greater than about 0.2%, greater than about 0.3%, greater than about 0.5%, greater than about 1%, or greater than about 5%.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the second portion of the ceramic includes a metal and wherein the atomic mole percentage of the metal includes a discontinuity where the atomic mole percentage changes dramatically over a short relative length at the polymer substrate external surface when measured from the external surface into the polymer matrix internal volume as would be expected by two well defined, adjacent, non-interacting materials.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, wherein the polymer matrix includes both convex and concave Gaussian geometric features, wherein the ceramic includes a metal, and wherein the ceramic atomic mole percentage of the metal in the convex features is equal to or greater than the ceramic atomic mole percentage of metal in the concave features. In some embodiments, the convex and concave Gaussian geometric features are hemispherical, parabolic, elliptical, logarithmic, linear, polynomial, or exponential in nature.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the ceramic includes a metal and the diffusion length of the metal is greater than about 1 μm in the polymer matrix volume for a temperature up to about 160° C. and a time period up to about 90 minutes, or wherein the ceramic includes a metal and the diffusion coefficient of the metal in the polymer matrix internal volume is less than about 10⁻⁸ m²/s, less than about 10-9 m²/s, less than about 10⁻¹⁰ m²/s, or less than about 10⁻¹² m²/s at standard laboratory conditions. In some embodiments, polymer matrix swelling agents are used to increase the mass transfer by diffusion.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the mass of the ceramic, as a percentage of the mass of the polymer-ceramic composite, is less than about 10%.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the ceramic includes less than about 2 grams per square meter, less than about 5 grams per square meter, less than about 10 grams per square meter, less than about 20 grams per square meter, less than about 50 grams per square meter, or less than about 100 grams per square meter of the nominal geometric surface area of the polymer-ceramic composite.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein at least a portion of the polymer substrate external surface does not include the first portion of the ceramic.

In some embodiments, a polymer-ceramic composite includes a polymer substrate that is a polymer film with an adhesive layer and a ceramic composite which is an interconnected nanostructured layer.

In some embodiments, a polymer-ceramic composite as described herein includes a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume, and wherein the polymer-ceramic composite also contains a functional molecule. In some embodiments, at least a portion of the functional molecules occupies the polymer matrix internal volume. In some embodiments, at least a portion of the functional molecule occupies the polymer matrix internal volume, extending more than about 10 nm into the polymer matrix internal volume. In some embodiments, the functional molecule concentration decreases when measured from the polymer matrix external surface into the polymer matrix internal volume. In some embodiments, at least a portion of the functional molecule occupies the polymer matrix internal volume, wherein the functional molecule concentration decreases at a decreasing rate from the polymer substrate external surface into the polymer matrix internal volume. In some embodiments, at least a portion of the functional molecule occupies the polymer matrix internal volume, wherein relative to an identical polymer substrate without the ceramic, the functional molecule penetrates a shorter distance into the polymer matrix internal volume of the polymer-ceramic composite. In some embodiments, at least a portion of the functional molecule occupies the polymer matrix internal volume, wherein the functional molecule diffusion coefficient in the polymer matrix internal volume is greater than about 5% less relative to an identical polymer substrate that does not include the ceramic.

In some embodiments, a polymer-ceramic composite as described herein also contains a functional molecule as described herein, and at least a portion of the composite material has a sessile drop water contact angle greater than about 90 degrees, greater than about 100 degrees, greater than about 110 degrees, greater than about 115 degrees, than about 120 degrees, greater than about 125 degrees, greater than about 128 degrees, greater than about 130 degrees, greater than about 131 degrees, than about 132 degrees, greater than about 134 degrees, greater than about 136 degrees, greater than about 138 degrees, greater than about 140 degrees, greater than about 142 degrees, greater than about 144 degrees, greater than about 146 degrees, greater than about 148 degrees, greater than about 150 degrees, greater than about 155 degrees greater than about 160 degrees, greater than about 165 degrees, greater than about 170 degrees, greater than about 175 degrees, greater than about 178 degrees, or about 179 degrees.

### Methods

Methods are provided for production of polymer-ceramic composite compositions as described herein.

In some embodiments the polymer substrate material absorbs metal salts or precursors, and the ceramic is produced in situ on the polymer substrate. In some embodiments these ceramic precursors or salts are dissolved into a solvent or solvent mixture that is absorbed into the polymer substrate. In some embodiments, the metal salts or precursors include a metal nitrate, a metal acetate, a metal sulfate, a metal chloride, or mixtures thereof. In other embodiments, the metal salts or precursors include a phosphate, a carbonate, an oxalate, a hydroxide, a sulfate, or mixtures thereof. In some embodiments, the metal comprising salts or precursors include the components of the ceramic. In some embodiments, the metal salts or precursors include metal organic complexes, such as, but not limited to, transition metal amine complexes, transition metal amide complexes, alkaline earth metal amine complexes, alkaline earth metal amide complexes, and coordination complexes of transition metals and amines. In some embodiments, the precursors include an oxidizing agent such as a permanganate, a persulfate, hydrogen peroxide, a chlorate, a perchlorate, or a hypochlorite which accelerates the formation of the ceramic on the polymer substrate. In other embodiments, the precursors include an amine, an amide, or ammonia which accelerates the formation of the ceramic on the polymer substrate. In some embodiments, the precursors include a catalyst which accelerates the precipitation of a ceramic on the substrate. In some embodiments, the precursors provide multiple benefits. In some embodiments the ceramic precursors include one or more of a metal salt, components of the ceramic, metal organic complexes, an oxidizing agent, an amine, an amide or ammonia.

Other nonlimiting examples of materials which may be added to the reactive solutions or rinses in order to provide process or operational benefits are penetrants and solvents, wetting agents, surfactants and dispersants, pH modifiers, anti-scaling chemicals, colorants, and defoaming agents.

In some embodiments, the metal salts or precursors are dissolved or dispersed into a solvent. In some embodiments, the polymer substrate is contacted with the solution that includes the metal salts or ceramic precursors and solvent. In some embodiments, the solution is absorbed into the polymer substrate.

In some embodiments, the polymer substrate is contacted or absorbed with multiple solutions (i.e., two or more solutions) that contain different metal salt or precursor compositions. For example, the multiple solutions may contain the same or different solvents. In some embodiments, the multiple solutions, if mixed, react to form a precipitant, such as the ceramic. In some embodiments, the reaction between these multiple solutions results in a double replacement reaction to form products that include at least one precipitant.

In some embodiments, the polymer substrate is contacted or absorbed with one solution that contains the one or more metal salt and/or one or more ceramic precursor.

In some embodiments, multiple solutions are used, which if exposed to a change in pH, would react under the new pH condition to form a precipitant, such as a ceramic. In some embodiments, the reaction between these solutions results in a double replacement reaction. In some embodiments, the products include at least one precipitant. In some embodiments, a single solution is used which contains the metal salts and/or ceramic precursors.

In some embodiments, the polymer substrate with absorbed solution that contains metal salts or ceramic precursors and solvent is heated. The heating may cause solvent evaporation and/or precipitation of ceramic. In some embodiments, there is a chemical reaction upon heating, such as, for example, precipitation of ceramic due to supersaturation, and/or migration of ceramic precipitant to the external surface of the polymer substrate. In some embodiments, at least a portion of the ceramic precipitant remains within the interior volume of the polymer matrix.

In some embodiments, the polymer substrate is dipped or submerged into a solution that includes a first salt and then dipped or submerged into a solution that includes a second salt, wherein the solutions absorb into the polymer or swell the polymer. In some embodiments, the polymer includes salts within the interior volume and/or on the external surface of the polymer substrate. In some embodiments, the polymer substrate is then heated to evaporate the solvent, react the salts, or a combination thereof. In some embodiments, the solutions migrate to the external surface of the polymer substrate during heating. In some embodiments, ceramic precipitates within the interior volume of the polymer matrix, on the external surface of the polymer substrate, or a combination thereof. In some embodiments, the ceramic protrudes outward from the external surface of the polymer substrate.

In some embodiments, the polymer substrate is contacted with a solution that includes a first salt, and then is contacted with a solution that includes a second salt, wherein the polymer substrate absorbs at least a portion of one or both of the solutions or swells upon being contacted with one or both of the solutions, and the solutions that independently include water or water and one or more cosolvents such as EGBE or DEGBE. In some embodiments, the polymer substrate is contacted with a combination of a first salt and a second salt, wherein the polymer substrate is first contacted with the first salt and then contacted with the second salt, the first salt includes one or more first ionic compounds nonlimiting examples of which are calcium nitrate tetrahydrate or magnesium nitrate hexahydrate, and the second salt includes one or more second ionic compounds nonlimiting examples of which are potassium phosphate dibasic or sodium oxalate dihydrate. In some embodiments, the contacting includes dipping the polymer substrate into one or more of the solutions, submerging the polymer substrate in one or more of the solutions, spraying the polymer substrate with one or more of the solutions, or a combination thereof.

In some embodiments, the polymer substrate is pre-treated before contacting with the solution that includes the one or more first ionic compounds. In some embodiments, the pre-treatment includes one or more of contacting the polymer substrate with a solution of sodium hydroxide from about 0.25% (w/w) to about 5% (w/w) for about 15 seconds to about 30 minutes, rinsing the polymer substrate with water or a solvent that includes water and a cosolvent, mechanically dewatering the polymer substrate, drying the polymer substrate under the ambient atmosphere at a temperature from about ambient temperature (e.g., about 20° C.) to about 140° C., and/or equilibrating the polymer substrate against ambient conditions.

In some embodiments, the polymer substrate is further treated after contacting with the solution that includes one or more first ionic compounds and before contacting with the solution that includes one or more second ionic compounds. In some embodiments, the first or second solution are at temperatures of about 20° C., about 20° C. to about 90° C., about 20° C. to about 50° C., about 30° C. to about 60° C., about 40° C. to about 80° C., about 50° C. to about 90° C., about 30° C., about 40° C., about 50° C., about 60° C., about 70° C., about 80° C. or about 90° C. In some embodiments, the first or second solutions are in contact with the substrates for about 1 second, about 2 seconds, about 5 seconds, about 1 second to about 120 seconds, about 5 seconds to about 20 seconds, about 10 seconds to about 30 seconds, about 20 seconds to about 60 seconds, about 30 seconds to about 80 seconds, about 40 seconds to about 90 seconds, about 50 seconds to about 100 seconds, about 60 seconds to about 120 seconds, about 70 seconds to about 110 seconds, about 80 seconds to about 120 seconds, about 10 seconds, about 15 seconds, about 20 seconds, about 30 seconds, about 60 seconds, about 90 seconds, or about 120 seconds before a drying step occurs. In some embodiments, the further treatment includes one or more of mechanically dewatering the polymer substrate and/or drying the polymer substrate under ambient atmosphere at a temperature from about ambient temperature (e.g., about 20° C.) to about 140° C.

In some embodiments, the solution that includes the one or more first ionic compounds and the solution that includes the one or more second ionic compounds independently include water or a solvent that includes water and one or more cosolvents. In some embodiments where the solvent includes water and one or more cosolvents, the ratio of water to the total of one or more cosolvents is from about 1:99 (v/v) to about 999:1 (v/v). In some embodiments where the solvent includes water and one or more cosolvents, the ratio of water to the total of one or more cosolvents is from about 1:99 (w/2) to about 999:1 (w/w). In some embodiments, the solvent is water. In some embodiments, the solvent is from about 0.25% (w/w) to about 50% EGBE in water (w/w). In some embodiments, the solvent is from about 0.5% (w/w) to about 5% EGBE in water (w/w). In some embodiments, the solvent is from about 1% (w/w) to about 2% EGBE in water (w/w). In some embodiments, the solvent is from about 0.25% (w/w) to about 50% DEGBE in water (w/w). In some embodiments, the solvent is from about 0.5% (w/w) to about 5% DEGBE in water (w/w). In some embodiments, the solvent is from about 1% (w/w) to about 2% DEGBE in water (w/w).

In some embodiments, the polymer substrate is dipped or submerged into a solution that includes a metal organic complex. In some embodiments, the polymer substrate includes the metal organic complex within the interior volume of the polymer matrix and/or on the external surface of the polymer substrate. In some embodiments, the polymer substrate is then heated to evaporate the solvent, decompose or react with the metal organic complex, or a combination thereof. In some embodiments, the heating decomposes the metal-organic complex into ceramic. In some embodiments, the solutions migrate to the external surface of the polymer substrate during heating. In some embodiments, ceramic precipitates within the interior volume of the polymer matrix, on the external surface of the polymer substrate, or a combination thereof. In some embodiments, the ceramic protrudes outward from the external surface of the polymer substrate.

In some embodiments the polymer substrate is dipped or submerged into a solution that includes a metal organic complex. In some embodiments, the polymer substrate includes the metal organic complex within the interior volume of the polymer matrix and/or on the external surface of the polymer substrate. In some embodiments, the polymer substrate is then contacted with a pH adjustment solution and/or with a catalyst containing solution to form a precipitate of ceramic. In some embodiments, the solutions migrate into the polymer substrate. In some embodiments, ceramic precipitates within the interior volume of the polymer matrix, on the external surface of the polymer substrate, or a combination thereof. In some embodiments, the ceramic protrudes outward from the external surface of the polymer substrate.

In some embodiments, the polymer substrate is dipped or submerged into a solution that contains a metal salt and an oxidizing agent. In some embodiments, the polymer substrate includes the metal salt and/or the oxidizing agent within the interior volume of the polymer matrix and/or on the external surface of the polymer substrate. In some embodiments, the polymer substrate is dipped sequentially into a solution containing a metal salt, followed by a solution containing an oxidizing agent. In some embodiments, the polymer substrate is first dipped into a solution containing an oxidizing agent followed by a solution containing a metal salt. In some embodiments, the oxidizing agent oxidizes the metal ions in solution and forms a ceramic precipitate within the interior volume of the polymer matrix and/or on the external surface of the polymer substrate. In some embodiments the ceramic protrudes outward from the external surface of the polymer substrate.

In some embodiments, the polymer substrate is contacted by a solution that contains a metal salt and an oxidizing agent by spraying, flooding, padding, or gravure coating. In some embodiments, the polymer substrate includes the metal salt and/or the oxidizing agent within the interior volume of the polymer matrix and/or on the external surface of the polymer substrate. In some embodiments, the polymer substrate is sequentially contacted by spraying, flooding, padding, or gravure coating with a solution containing a metal salt, followed by a solution containing an oxidizing agent. In some embodiments, the polymer substrate is first sprayed, flooded, padded, or gravure coated into a solution containing an oxidizing agent followed by a solution containing a metal salt. In some embodiments, the oxidizing agent oxidizes the metal ions in solution and forms a ceramic precipitate within the interior volume of the polymer matrix and/or on the external surface of the polymer substrate. In some embodiments the ceramic protrudes outward from the external surface of the polymer substrate.

In some embodiments the polymer-ceramic composite is functionalized via spraying, immersing, dipping, vapor depositing, spin coating, gravure coating, knife coating, or roll coating. In some embodiments the functionalized molecule applied in the functionalization step is one or more of a silane, a siloxane, a urethane, an acrylate, or a molecule with a head group and a tail group (for example, wherein the head group includes a silane group, a phosphonate group, a phosphonic acid group, a carboxylic acid group, a vinyl group, an alcohol group, a hydroxide group, a thiolate group, a thiol group, and/or an ammonium group (e.g., a quaternary ammonium group), and wherein the tail group includes a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group. In some embodiments the functional molecule is dissolved in a solvent such as water, an alcohol, such as but not limited to isopropanol, methanol, or ethanol, an alkane such as a hexane or a heptane, an aromatic hydrocarbon, such as, but not limited to a xylene or toluene. In some embodiments the functionalized polymer ceramic is cured at elevated temperatures to stabilize the functional molecule.

In some embodiments, a polymer-ceramic composite includes a polymer substrate that is a polymer film with an adhesive layer and a ceramic composite which is an interconnected nanostructured layer that is transferred to the adhesive layer by direct or contact transfer. In some embodiments, direct or contact transfer is achieved by cold or hot pressing, rolling, peeling, or laminating. In some embodiments, an adhesive layer is used to facilitate the transfer. In some embodiments, the interconnected nanostructured layer is directly transferred to the substrate. In some embodiments, the interconnected nanostructured layer is removed from the substrate and transferred using a liquid carrier.

### EXAMPLES

The following examples are intended to illustrate, but not limit, the invention.

### Example 1

A lightweight (~2 oz/yd), 50D (denier), rip-stop nylon was used as the polymer substrate for the deposition of ceramic. The polymer substrate material was cleaned with a 2% NaOH scouring process by immersion in solution for about 10 minutes, rinsed with water, mechanically dewatered, air-dried at temperatures of about 105° C., and conditioned to laboratory conditions.

These cleaned substrates were then processed via batch solution contact by immersion in alternating 25 mM solutions of a calcium source (i.e., calcium nitrate tetrahydrate) and a similar concentration of a phosphate source (i.e., ammonium phosphate dibasic) at a temperature of about 20° C. for about 30 seconds (sec) per stage. Samples were treated by sequential solution contact by immersion to generate more uniformly deposited structures and particulates. Samples were dewatered with mechanical rollers to increase uniformity and reduce particulate formation in the immersion baths. The samples were air-dried at room temperature after the solution contact by immersion cycles until dry and then annealed at a temperature of about 140° C. for about 10 minutes. The result was the deposition of a structured ceramic on the nylon substrate. The deposit structure was imaged to assess uniformity and characterize the material.

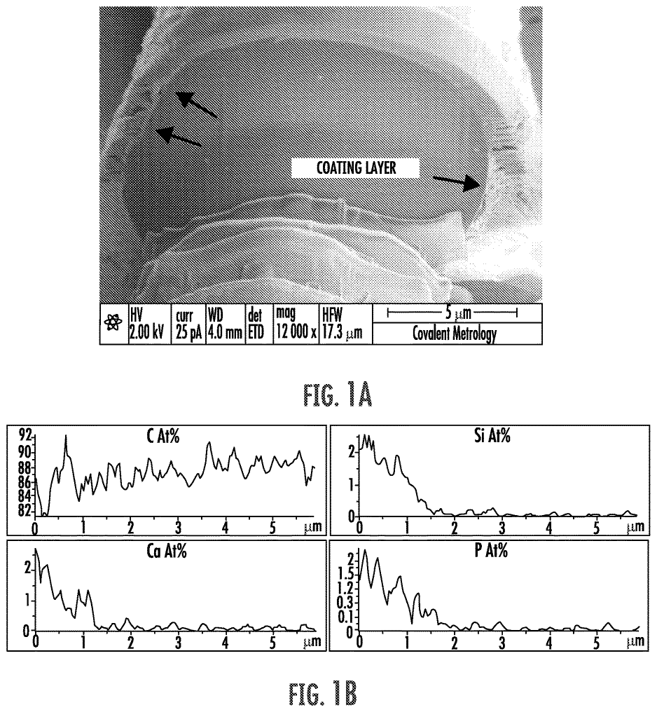

Results are shown in FIG. 1a and FIG. 1b. A representative fiber was cross-sectioned and imaged with a scanning electron microscope (SEM) and the concentration of elements was measured along the radius of the fiber with energy dispersive x-ray spectroscopy (EDS). The circularity of the fiber in FIG. 1a was estimated by SEM analysis to be about 0.95. The line scan begins from the exterior of the fiber and moves towards the center of the fiber. The concentration of the calcium and phosphate is highest outside of the fiber exterior and decreases to a minimum at about 1.5 μm from the exterior surface of the fiber. The EDS line scan shows the calcium concentration ([Ca]) to be approximately 2.5 wt % at the external surface of the polymer substrate, about 1 wt % at a depth of about 0.7 μm into the polymer substrate (below the external surface of the polymer substrate), and reaching a value of about 0.1 wt % at the 1.5 μm depth. The profile is reasonably modeled with an error function diffusion profile for a fixed surface concentration and a semi-infinite solid approximation. Approximately 80% of the ceramic is protruding outward from the polymer layer and approximately 20% of the ceramic partially occupies the internal volume of the polymer matrix. Excessive solution contact by immersion times or concentrations generated excess material, which resulted in a non-uniform appearance that can be described by spots, streaks, color changes or other defects from the fabric surface when viewed by the unaided eye.

The processed deposit structure was further functionalized to impart hydrophobic properties via batch solution contact by immersion in an ethanol solution with about 20 mM hexadecyltriethoxysilane (HDTES), about 3 wt % water and a catalytic amount of acetic acid solution for about 10 minutes and then annealed at a temperature of about 140° C. for about 10 minutes.

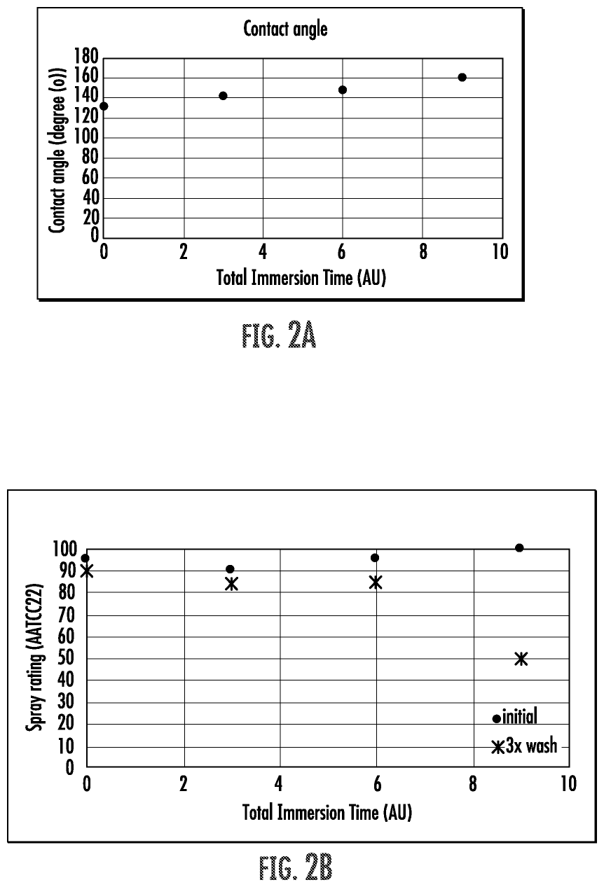

The samples were tested and evaluated to AATCC 22 standards for spray rating and were observed to possess water resistance by spray ratings greater than 90. Contact angle measurements indicated increasing contact angle with repeated cycles, as shown in FIG. 2a. Wash resistance was measured by washing the material in a household washer for 3 wash/dry cycles. The samples were re-tested and rated to AATCC 22 standards and were observed to possess spray ratings greater than 80 for most conditions, as shown in FIG. 2b. Air permeability was measured according to ASTM D737 after processing and remained within 25% of the untreated fabric condition, after processing and after washing.

SEM analysis before and after washing shows good adhesion of the ceramic to the polymer substrate as no loosely adhered material or regions that appear to have material previously present were observed.

### Example 2

Materials processed according to the steps outlined in Example 1 to form the processed deposit structure were further functionalized to impart hydrophobic properties via batch solution contact by immersion with several formulations as outlined below in Table 1.

The samples were tested and evaluated to AATCC 22 standards for spray rating and were observed to possess water resistance by spray ratings greater than 90. Contact angle measurements indicated increasing contact angle with repeated solution contact by immersion cycles. Wash resistance was measured by washing the material in a household washer for 3 wash/dry cycles in a home washer. The samples were re-tested and rated to AATCC 22 standards and were observed to spray ratings greater than 70. Air permeability was measured after processing and remained within 30% of the untreated fabric condition, after processing and after washing. These results demonstrate both the improvement in contact angle with the processed deposit structure and the compatibility of the processed deposit structure with several functional formulations.

SEM analysis of the samples before and after washing shows good adhesion of the ceramic to the polymer substrate as no loosely adhered material or regions that appear to have material previously present were observed

TABLE 1

| | | | | | Silicone | Silicone | Silicone |
|---|---|---|---|---|---|---|---|
| | | | Example 1 | | formulation | formulation 2 | formulation 3 |
| | Example 1 | | with added | | with blocked | with urethane | with urethane |
| | Functional | | Silane | Silicone | isocyanate | containing | containing |
| | Layer Only | Example 1 | Crosslinker | formulation | crosslinker | crosslinker | crosslinker |
| Contact | 131 | 141 | 139 | 131 | 135 | 132 | 134 |
| angle | | | | | | | |
| Contact | 125 | 131 | 130 | 124 | 133 | 130 | 129 |
| angle | | | | | | | |
| (after | | | | | | | |
| wash) | | | | | | | |
| Spray | 95 | 98 | 98 | 88 | 95 | 100 | 100 |
| rating | | | | | | | |
| Spray | 90 | 88 | 88 | 70 | 93 | 95 | 90 |
| rating | | | | | | | |
| (after | | | | | | | |
| wash) | | | | | | | |

### Example 3

A light weight (~2 oz/yd), 50D (denier), rip-stop nylon was used as the substrate for the deposition of ceramic. The polymer substrate material was cleaned with a 2% NaOH scouring process by immersion in solution for about 10 minutes, rinsed with water, mechanically dewatered, air dried at temperatures of about 105° C., and conditioned to laboratory conditions.

These cleaned substrates were then processed via batch solution contact by immersion in alternating about 25 mM solutions of calcium source (calcium nitrate tetrahydrate) and an oxalate source (sodium oxalate dihydrate) at similar concentrations and temperatures of about 20° C. for about 30 seconds per stage. Samples were treated for sequential cycles to generate more uniformly deposited structures and particulates. Samples were dewatered with mechanical rollers to increase uniformity and reduce particulate formation in the immersion baths. The samples were air dried at room temperature after the immersion cycles until dry and then annealed at a temperature of about 140° C. for about 20 minutes. The result was the deposition of a structured ceramic on the nylon substrate. The deposit structure was imaged to assess uniformity and characterize the material.

The processed deposit structure was further functionalized to impart hydrophobic properties via batch immersion into a mixture of commercially available PFC-free products. In one case, the top coating mixture contained a nonionic polymer and surface-active compound with a glycol based solvent and water, a weakly cationic, silicone containing water repellent agent, and a blocked isocyanate crosslinking compound. The processed deposit structure was immersed in the lightly agitated solution at laboratory temperature (about 20° C.) for less than 5 minutes and then annealed in two stages, at a temperature of about 130° C. for less than 2 minutes and about 170° C. for less than 2 minutes. In another top coating mixture, which included a high solids silicone emulsion concentrate diluted with water and a blocked isocyanate crosslinking compound, the processed deposit structure was immersed in the lightly agitated solution at laboratory temperature (about 20° C.) for less than 5 minutes, mechanically squeezed by nip rolling to remove excess liquid, and then annealed in two stages, at a temperature of about 160° C. for less than 5 minutes.

In both cases, the samples were tested and evaluated to AATCC 22 standards for spray rating and were observed to possess water resistance by spray ratings greater than 90. Contact angle measurements indicated increasing contact angle with repeated cycles and increasing concentrations.

Excessive first and second solution contact by immersion times of greater than 5 minutes or concentrations of first and second contact solutions of about 250 mM or greater generated excess material, which resulted in visual non-uniformities becoming apparent when viewed with an unaided eye.

Cleaned substrates were also produced by alternating solution contact by immersion in solutions about 25 mM first solutions of calcium source (calcium nitrate tetrahydrate) and alternating second solutions of phosphate sources and oxalate sources (sodium oxalate dihydrate) at temperatures of about 20° C. for about 30 seconds per stage, which resulted in a similar ceramic structure as the ceramic structures generated from alternating calcium and oxalate or calcium and phosphate sources alone.

### Example 4

A lightweight (~2 oz/yd), 50D (denier), rip-stop nylon was used as the substrate for the deposition of ceramic. The polymer substrate material was cleaned with a 2% NaOH scouring process by immersion in solution for about 15 minutes, rinsed with water, mechanically dewatered, air-dried at a temperature of about 105° C., and conditioned to laboratory conditions.

These cleaned substrates were then processed via batch immersion in at least one first solution that included a metal salt, a metal-organic complex, or other reactive precursors, wherein the solution was absorbed into the polymer. The polymer substrate was then heated to a temperature that was sufficient to remove the solvent from the polymer, and sufficient to drive a ceramic-forming reaction with the metal salts, or sufficient to decompose or react the metal-organic complex in such a way as to form an insoluble ceramic.

In this method of manufacture, the metal salt included a transition metal nitrate, transition metal chloride, transition metal sulfate, transition metal acetate, alkaline earth metal nitrate, alkaline earth metal chloride, alkaline earth metal sulfate, alkaline earth metal acetate, or combinations thereof, or the metal-organic complex included a metal-amine complex, wherein the amine included a free amine.

In this method of manufacture, the absorption diffusion included solution contact by immersion in a soluble precursor containing solution for about 10 sec to about 72 hrs at temperatures from about 20° C. to about 160° C., and solvent removal and reaction temperature ranged from about 30° C. to about 200° C. for about 10 sec to about 10 minutes. The absorption step was carried out in both batch and a continuous process manner. Samples were treated in sequential solution contact by immersion cycles to generate more uniformly deposited structures and particulates. Samples were dewatered with mechanical rollers to increase uniformity and reduce particulate formation in the immersion baths. The result was the deposition of a structured ceramic on the nylon polymer substrate. The deposit structure was imaged to assess uniformity and characterize the material. Ceramic was formed under these conditions. Excessive solution contact by immersion times or concentrations generated excess material which resulted in a non-uniform appearance when viewed by the unaided eye.

The processed deposit structure was optionally further functionalized to impart hydrophobic properties via batch immersion of the sample with an ethanol solution with about 20 mM hexadecyltriethoxysilane (HDTES), about 3 wt % water and a catalytic amount of acetic acid solution for about 10 minutes or silicone containing solutions with silicone concentrations from about 2 wt % to about 6 wt % for about 2 minutes. Samples were annealed at temperatures from about 120° C. to about 180° C. for about 0.5 minutes to about 15 minutes. The samples were tested and evaluated to AATCC 22 standards for spray rating and were observed to possess water resistance by spray ratings greater than 90. Contact angle measurements indicated increasing contact angle measurements at increasing concentrations of ceramic forming reactants.

SEM analysis before and after washing shows good adhesion of the ceramic to the polymer substrate as no loosely adhered material or regions that appear to have material previously present were observed.

### Example 5

A lightweight (~1.5 oz/yd), 20D (denier), rip-stop PET polyester was used as the substrate for the deposition of ceramic. The substrate material was cleaned with a 2% NaOH scouring process by immersion in solution for about 1 minute, rinsed with water, mechanically dewatered, air-dried at a temperature of about 105° C., and conditioned to laboratory conditions.

These cleaned substrates were then processed via batch solution contact by immersion in alternating first solutions of 25 mM to 500 mM of calcium source and second solutions of 15 mM to 500 mM phosphate source. First and second solution temperatures were about 20° C. and cycle times as low as about 10 seconds were used. Samples were treated in sequential immersion cycles to generate more uniformly deposited structures and particulates. Samples were dewatered with mechanical rollers to increase uniformity and reduce particulate formation in the immersion baths. The samples were air dried at room temperature after the solution contact by immersion cycles until dry and then annealed at a temperature of about 80° C. to about 160° C. for a few minutes. The result was the deposition of a structured ceramic on the nylon substrate as measured by XRF. The deposit structure was imaged to assess uniformity and characterize the material. Lower concentrations of contact solutions resulted in discrete particulate. Higher concentrations resulted in an agglomerated type of structure. Solution concentrations greater than 500 mM or excessive cycles generated excess material, which resulted in a non-uniform appearance when viewed by the unaided eye. The circularity of the fibers were estimated by SEM investigation to be greater than about 0.7.

The processed deposit structure was further functionalized to impart hydrophobic properties via batch immersion of samples in an ethanol solution with about 20 mM hexadecyltriethoxysilane (HDTES), about 3 wt % water and a catalytic amount of acetic acid solution for about 10 minutes or silicone containing solutions with silicone concentrations from about 2 wt % to about 6 wt % for about 2 minutes and then annealed at temperatures of about 120° C. to about 180° C. for a few minutes. The samples were tested and evaluated to AATCC 22 standards for spray rating and were observed to possess water resistance by spray ratings greater than 90. Contact angle measurements indicated increasing contact angle with increasing concentrations of ceramic reactants or repeated contact by immersion cycles. Wash resistance was measured by washing the material in a household washer for 3 wash/dry cycles in a home washer. The samples were re-tested and rated to AATCC 22 standards and were observed to spray ratings greater than 80. Samples with non-uniform appearance did not perform as well as more uniform samples. Air permeability was measured after processing and remained within 25% of the untreated fabric condition, after processing and after washing.

### Example 6

Alternative polymer substrates with densities of up to 5 oz/yd and 300D (denier) of polyester or nylon including up to 100% recycled polymer content or blended substrates including nylon or polyester, were processed according to the steps outlined in Example 1. One such fabric is a 95% recycled nylon, 5% spandex plain weave fabric of 150D (denier). This polymer substrate has a density of about 150 g/m² and an air permeability of about 3 cfm.

The processed polymer substrate was then further functionalized to impart hydrophobic properties via batch contact by immersion with several topcoat formulations. The samples were tested and evaluated to AATCC 22 standards for spray rating and are observed to possess water resistance by spray ratings greater than 90. Contact angle measurements indicated increased contact angle when compared to the bare polymer substrate.

### Example 7

A light weight nylon rip-stop fabric of about 64 g/m² was used as the polymer substrate for the deposition of ceramic. Several metallic precursor solutions were investigated including Ni, Zn, Cu, and Mn. About 40 mL of about 1M X(II)SO₄ and about 30 mL of about 0.25M potassium persulfate (KPS) where X is Ni, Zn, Cu, or Mn were mixed in a container. About 10 mL of ammonia was added slowly as about 28% NH₃. The mixture was stirred for about 30 sec and diluted to about 100 mL with deionized water. Polymer substrate samples were added to the mixture quickly, within about 10 min from the addition of the ammonia solution. The polymer substrates remained immersed in solution for about 30 minutes, about 60 minutes, about 90 minutes and about 18 hours, and the resulting coated substrates were imaged.

The copper solutions were not stable and did not result in consistent observations. The resulting structures on the substrate fibers for Ni, Zn and Mn were observed to exhibit an interconnected series of plates and pores coating the fibers, having lateral dimensions less than about 1 μm and a thickness of less than about 0.2 μm. Increased solution contact by immersion time resulted in a larger and more porous structure than the shorter solution contact by immersion times, which resulted in a denser more film like structure. Excessive solution contact by immersion times or concentrations generated excess material, which resulted in a non-uniform appearance when viewed by the unaided eye.

The treated substrates were observed to have much faster wetting than the untreated nylon fabric. The ceramic structure of the Ni on the nylon substrate was very uniform around the fibers and was not easily removed through rubbing.

The treated substrate samples were further processed with a silane containing ethanol mixture and annealed in a manner similar to as described in Example 1 above. The Ni treatments were unsuccessful and did not decrease the hydrophilicity of the treated nylon. The functionalization of the Zn and Mn treated structures increased the contact angle of the coated substrate when compared to the standard substrate similarly functionalized.

### Example 8

A lightweight (~2 oz/yd), 50D (denier), rip-stop nylon, and a light weight (~1.5 oz/yd), 20D (denier), rip-stop polyethylene terephthalate (PET) polyester were used as polymer substrates for the deposition of ceramic.

First solutions containing concentrations of about 400 mM, about 100 mM, about 25 mM, about 5 mM, and about 1 mM manganese sulfate and up to about 2 wt % of either ethylene glycol butyl ether or diethylene glycol monobutyl ether (DEGBE) were prepared into reaction containers. The polymer substrates were added to the 50 ml polypropylene tubes containing the solutions and allowed to equilibrate at 25° C. for a period of about 72 hours on an orbital shaker. The samples were then removed and dried in an oven at a temperature of about 105° C. for about 10 min.

Second reaction solutions containing about 75 mM potassium persulfate and about 1.5 M ammonia were prepared and held at a temperature of about 25° C. The samples exposed to the first solutions were then added to these second reaction solutions for about 90 min. The samples were then removed and rinsed thoroughly with DI water to remove any loosely adhered material. After rinsing, the samples were dried in an oven at a temperature of about 140° C. for about 10 min. The prepared samples were imaged via scanning electron microscope to examine the resulting ceramic structures formed on the polymer substrates. The resulting structures were similar, comprising an interconnected series of plates and pores coating on the polymer substrate fibers having lateral dimensions less than 1 μm and a thickness of less than about 0.2 um. The nanostructured plates had a wall thickness of approximately 20 nm. Excessive first solution concentrations of 100 mM or greater generated excess material, which resulted in a non-uniform appearance when viewed by the unaided eye.

The treated substrates were then further processed with a silane containing ethanol mixture and annealed in an oven in a manner similar to the process described in Example 1. The functionalization resulted in a higher water contact angle of the coated substrate when compared to a standard nylon substrate with a similar functionalization.

### Example 9

A light weight (~2 oz/yd), 50D (denier), rip-stop nylon and a light weight (~1.5 oz/yd), 20D (denier), rip-stop PET polyester were used as the substrates for the deposition of ceramic.

The fabric samples were cut into strips and placed in a 2 wt % aqueous NaOH bath for about 2 minutes and thoroughly rinsed to clean the fabric surface. The samples were then immersed for about 60 minutes in aqueous baths held at a temperature of about 70° C. containing either about 25 mM, about 50 mM, or about 100 mM KmnO₄ each with 200 mM NH₃. The samples were rinsed and dried at a temperature of about 105° C. for about 60 minutes. They were then subsequently immersed in second baths containing equimolar concentrations of Mn(NO₃)₂ and hexamethylenetetramine at concentrations of about 25 mM, or about 50 mM, or about 75 mM, or about 100 mM. Samples were immersed at a temperature of about 80° C. for about 60 minutes, thoroughly rinsed, and dried at a temperature of about 105° C. for about 60 minutes.

The microstructure of the surface was analyzed by SEM and a dense nanostructured shell was formed on the outside of the textile fibers containing manganese oxides and hydroxides. Excessive solution contact by immersion times or concentrations of about 50 mM Mn(NO₃)₂ generated excess material, which resulted in a non-uniform appearance when viewed by the unaided eye.

### Example 10

A light weight (~2 oz/yd), 50D (denier), rip-stop nylon and a light weight (~1.5 oz/yd), 20D (denier), rip-stop PET polyester were used as substrates for the deposition of ceramic.

The fabric samples were cut into strips and placed in a 2 wt % aqueous NaOH bath for about 2 minutes and thoroughly rinsed to clean the fabric surface. The cleaned fabric strips were immersed for about 30 seconds in an aqueous bath held at a temperature of about 20° C. containing 50 mM each of manganese nitrate and hexamethylenetetramine. The fabric samples were then transferred to an aqueous solution of about 100 mM NaOH at a pH greater than about 12 and immersed for 30 seconds. Brown precipitates were observed in the NaOH bath immediately upon textile introduction which was indicative of a surface reaction. The samples were then removed from the solution and dried at a temperature of about 140° C. for about 10 minutes before being imaged via SEM.

A dense nanostructured shell of manganese hydroxide was observed on the surface of the nylon and polyester fabrics when imaged by SEM. The composition of the coating was confirmed with energy dispersive x-ray spectroscopy (EDS) and the coating was found to contain a mixture of manganese and oxygen on top of the mostly carbon-containing polymer surface. Excessive solution contact by immersion times or concentrations generated excess material, which resulted in a non-uniform appearance when viewed by the unaided eye.

The structures were then functionalized with a hydrophobic treatment similar to as described in Example 1, which resulted in an increased contact angle compared to the untreated fabric.

### Example 11

A light weight (~2 oz/yd), 50D (denier), rip-stop nylon and a light weight (~1.5 oz/yd), 20D (denier), rip-stop PET polyester were used as substrates for the deposition of ceramic.

The fabric samples were cut into strips and placed in a 2 wt % aqueous NaOH bath for 2 minutes and thoroughly rinsed to clean the fabric surface. The cleaned fabric strips were immersed for about 30 seconds in an aqueous bath held at a temperature of about 20° C. containing about 50 mM of manganese nitrate. The fabric samples were transferred to an aqueous solution of 100 mM NaOH at a pH greater than 12 and immersed for 30 seconds. Brownish precipitates were observed in the NaOH bath immediately upon textile introduction which was indicative of a surface reaction. The samples were then removed from the solution and dried at a temperature of about 140° C. for 10 minutes before being imaged via SEM.

A fine agglomeration of manganese hydroxide nanoparticles was observed on the surface of the nylon and polyester fabrics when imaged by SEM. The composition of the coating was confirmed with energy dispersive x-ray spectroscopy (EDS) and the coating was found to contain a mixture of manganese and oxygen on top of the mostly carbon-containing polymer surface. Excessive solution contact by immersion times or concentrations generated excess material, which resulted a non-uniform appearance when viewed by the unaided eye.

The structures were then functionalized with a hydrophobic treatment similar to as described in Example 1, resulting in an increased contact angle compared to the untreated fabric.

### Example 12

A lightweight (~2 oz/yd), 50D (denier), rip-stop nylon was used as polymer substrates for the deposition of ceramic. Samples were immersed into a first solution, removed, and dried at a temperature of about 140° C. for 10 min, immersed into a second solution, removed and rinsed twice in DI water, and dried at a temperature of about 140° C. for about 10 minutes.

First solutions contained about 1 mM, about 5 mM, about 25 mM, about 100 mM, about 400 mM, or about 1000 mM of Mn(SO₄) and about 170 mM ethylene glycol butyl ether (EGBE). Samples were immersed into the first solutions at either about 60° C. for about 2 hrs, about 60° C. for about 18 hrs, or about 40° C. for about 72 hrs. Each solution contact by immersion took place in 50 mL vials on a shaker table set to 75 rpm. Samples were removed and dried at a temperature of about 140° C. for about 10 minutes.

Each of the samples was then contacted with a second solution at a temperature of about 25° C. for about 1.5 hrs. The second solution contained about 75 mM of K₂S₂O₈ and about 1453 mM NH₃. Samples were removed, rinsed twice with deionized (DI) (Type II) water, and dried at a temperature of about 140° C. for about 10 minutes.

Samples were then contacted by immersion with silane containing solution similar to as described in Example 1 and cured in an oven to evaluate the impact on sessile contact angle.

The samples were imaged by SEM and showed little difference among the first solution contact by immersion solution exposure conditions. The samples with first solution concentrations greater than about 400 mM showed a contiguous interconnected platelike, nanostructured layer and some larger discrete particulates; some cracking of the contiguous structure was observed. The nanostructured layers had a thickness of less than about 0.2 μm. The remaining samples showed some discrete structures, with dimensions less than 1 μm in size.

The prepared substrates were then functionalized with a hydrophobic treatment, resulting in increased contact angles as compared to the unprepared substrates with the same treatment. Samples with a first solution concentration greater than about 25 mM resulted in sessile droplet contact angles ranging from about 140° to about 165°. Samples with first solution concentrations less than about 25 mM resulted in sessile droplet contact angles less than about 130°.

### Example 13

Light weight (~2 oz/yd), 50D (denier), rip-stop nylon substrates were immersed in a slightly acidic solutions including calcium ranging from about 5 mM to about 200 mM. The time periods and conditions of exposure ranged from about 20° C. to about 140° C. for time periods of about 30 sec to about 24 hrs. Temperatures above about 100° C. were evaluated by heating the solution in an autoclave reactor.

Samples were epoxy mounted and polished for cross section SEM-EDS to quantify compositions and gradients. With about 24 hrs of exposure to an about 25 mM Ca solution at a temperature of about 25° C., the samples showed no appreciable composition of Ca in the fiber cross section. With 3 hrs exposure to an about 25 mM Ca solution at a temperature of about 130° C., the samples showed a composition of about 0.02 at % Ca was detected in the bulk of the fibers.

These results indicate a concentration ratio (defined as the concentration at a depth in the polymer substrate divided by concentration at the polymer substrate surface) of about 1, assuming a diffusion coefficients of about 1e⁻¹¹ m²/sec at 25° C. The concentration ratio at a depth of about 20 μm is expected to be about 95%, about 80%, and about 40% after about 1 hour of exposure, about 5 minutes of exposure, or about 30 seconds of exposure, respectively.

### Example 14

Light weight (~2 oz/yd), 50D (denier), rip-stop nylon substrates were immersed into a slightly acidic solutions of calcium, at concentrations of about 25 mM, about 100 mM, about 250 mM, and about 500 mM for about 30 seconds. On removal, the immersed substrates were dewatered with a mechanical roller. The substrates were then immersed for about 30 seconds into second solutions containing a phosphate salt concentration of either about 15 mM, about 60 mM, about 150 mM or about 300 mM. On removal, the immersed substrates were dewatered with a mechanical roller. The substrates were then subject to a heated drying step of up to about 140° C. for about 10 minutes. Excessive solution contact by immersion times or concentrations generated excess material, which resulted in a non-uniform appearance when viewed by the unaided eye.

The processed substrates were further functionalized to impart hydrophobic properties via batch solution contact by immersion into a mixture including silane and siloxane containing solutions and cured in a manner similar to the conditions described in Example 1. The sessile contact angle of water on the processed and functionalized substrates was investigated and compared to functionalized substrates which were not subjected to the first and second solutions. The first and second solution functionalized substrates and the substrates which were only functionalized were then washed in a typical household clothes washer to evaluate the stability and durability of the hydrophobic properties. The functionalized substrates had contact angles of approximately 130° initially with a reduction of about 5° on washing. The first and second solution treated, functionalized substrates had contact angles of greater than about 132° to greater than about 140° depending on the concentrations. The reduction in contact angle indicates wash durability and ranged from as little as about a 1% reduction to over about a 10% reduction depending on the concentrations, as shown in Table 2. At moderate concentrations across the ranges tested, the reduction in contact angle was less than about 5%, demonstrating an optimal processing range.

TABLE 2

| | Contact angle reduction on |
|---|---|
| Calcium Concentration | washing |
| Zero | 5.3% |
| Low | 5.2% |
| Med | 1.5% |
| High | 8.8% |
| Very high | 11.3% |

### Example 15

Samples of light weight (~2 oz/yd), 50D (denier), rip-stop nylon were used as the substrate for the deposition of ceramic.

Samples were placed into reaction vessels in an orbital shaker operated at about 75 rpm, with temperature setpoint of about 40° C. for a period of about 72 hours. First solutions at about 1 mM, about 5 mM, about 25 mM, about 100 mM, and about 0.4 M manganese sulfate and about 2 wt % of ethylene glycol butyl ether were prepared into reaction vessels. After the diffusion period, the samples were removed, and dried at temperatures up to about 105° C. for a period of about 10 minutes. The samples were then placed into reaction vessels containing second solutions of potassium persulfate at about 75 mM and ammonia at about 1.5 M and immersed for a period of either about 90 minutes or about 18 hours. After this test period, samples were well rinsed in deionized water, and removed to dry at temperatures up to about 140° C. for a period of about 10 minutes.

At the 90 minute time point for solution contact by immersion, contiguous structures were observed on the substrate when concentrations greater than about 25 mM of metal sulfate were included in the initial solution, and discontinuous structures were observed when concentrations above about 5 mM of metal sulfate were included in the initial solution. There was no significant observed difference between samples which were immersed for about 90 minutes or about 18 hrs. Inductively coupled plasma—optical emission spectroscopy (ICP-OES) measurements of the samples indicated a linear relationship between the first solution concentrations and measured metal content of the sample.

### Example 16

Alternative polymer substrates, including polyethylene terephthalate (PET), polyamides or Nylon, polyvinyl chloride (PVC), polyolefins such as polyethylene or polypropylene, polyurethanes, polyols, polyvinyl alcohols (PVOH), polyethylene glycol (PEG), vinyl acetate, polyvinyl pyrrolidone, mixtures thereof, or copolymers thereof, were processed according to the steps outlined in Example 1 or Example 9 to form a processed deposit structure, and were further functionalized to impart hydrophobic properties via batch solution contact by immersion with several top coat formulations.

In one case, a polyvinyl alcohol synthetic canvas material with a density of about 230 g/m² was used a polymer substrate. A water rinse based treatment was used, which included immersion in water at a temperature of about 25° C. for about 5 minutes, and removing the water via a nip roller. This process removed material that negatively impacted water repellency performance by about 10-25 rating points in AATCC 22 testing.

A wax coated version of the same polymer substrate was measured to have a AATCC spray rating of 95, an air permeability of 0 cfm, a sessile contact angle of about 130° and a surface energy rating (by AATCC193) of 6.5.

After the pretreatment process, the polymer substrate was processed according to the conditions of Example 1, resulting in an AATCC spray rating of 80, an air permeability of 4.2 cfm, a sessile contact angle of about 141° and a surface energy rating (by AATCC193) of 7.

After the pretreatment process, the polymer substrate was processed according to the conditions of Example 9, resulting in an AATCC spray rating of 95, an air permeability of about 4.5 to about 6 cfm, a sessile contact angle of about 151° and a surface energy rating (by AATCC193) of 7. The fabric density was reduced to about 200 g/m².

### Example 17

Alternative polymer substrates, including a hydrocolloid such as a polysaccharide, or locust bean gum, starch, carrageenan, pectin, chitosan, xanthan gum, cellulose, or carboxymethyl cellulose, were processed according to the steps outlined in Example 1 to form the processed deposit structure, and were further functionalized to impart hydrophobic properties via batch solution contact by immersion with several topcoat formulations.

Two different samples of polymer matrix substrates containing cellulose were processed and evaluated for the deposition of ceramic. The 8″×8″ kraft paper samples of initial weight about 85 g/m² and about 125 g/m² were used as the substrates.

These substrates were processed via batch solution contact by immersion in alternating 25 mM solutions of a calcium source (i.e., calcium nitrate tetrahydrate) and a similar concentration of a phosphate source (i.e., ammonium phosphate dibasic) at a temperature of about 20° C. for about 30 seconds (sec) per stage. Samples were treated by sequential solution contact by immersion to generate more uniformly deposited structures and particulates. The samples were air-dried at room temperature after the solution contact by immersion cycles until dry and then annealed at a temperature of about 140° C. for about 10 minutes. The substrates were then immersed in an alkyl silane solution of about 1% silane for about 10 minutes and then annealed at a temperature of about 140° C. for about 10 minutes. The result was the deposition of a structured ceramic on the cellulose substrate.

A structured deposit of calcium phosphate was observed on the surface of the cellulose matrix when imaged by SEM. The composition of the coating was confirmed with dispersive x-ray spectroscopy (EDS) and the coating was found to contain a mixture of calcium, phosphorus, and oxygen on top of a mostly carbon containing polymer surface. The substrates were analyzed for moisture vapor transmission (MVTR) via the desiccant method described in ASTM-E96. The substrates did not show a significant change in MVTR from unprocessed substrates. The substrates were then analyzed for water contact angle after lab conditioning and after tape adhesion via sessile drop. The 125 g/m² substrate was found to have a water contact angle of about 1450 and was unaffected by tape adhesion and removal. The 85 g/m² substrate was found to have a water contact angle of about 150° and was unaffected by tape adhesion and removal. The substrates were then analyzed for surface energy via AATCC TM-193. The 125 g/m² substrate was found to have a surface energy rating of about 5 and the 85 g/m² substrate was found to have a surface energy rating of about 4.

### Example 18 (Prophetic)

Alternative polymer substrates, including wool, cotton, hemp, animal hair, collagen, keratin, silk, chitin, flax, jute, hydroxyapatite, enamel, or mixtures thereof, are processed according to the steps outlined in Example 1 to form the processed deposit structure, and are further functionalized to impart hydrophobic properties via batch solution contact by immersion with several topcoat formulations.

### Example 19 (Prophetic)

A lightweight (~2 oz/yd), 50D (denier), polyester fabric, such as a PET polyester, or medium weight nylon fabric, such as 75-200D nylon 6,6, or heavier-weight co-polymer fabric such as cotton-polyester (about 200-400D), or stretch fabric such as nylon-elastane is used as the polymer substrate to deposit ceramic. The polymer substrate is optionally cleaned with a 1% NaOH scouring process by immersion in the 1% NaOH solution for about 15 minutes, rinsed with water, optionally mechanically dewatered, air-dried at temperature of about 105° C., and conditioned to laboratory conditions.

This substrate is then processed via batch solution contact by immersion in alternating first contact solutions and second contact solutions. The first solutions contain about 25 mM to about 500 mM of a calcium source, such as calcium nitrate tetrahydrate, calcium nitrate hydrate, or calcium chloride, and the second solutions contain about 15 mM to about 300 mM of a phosphate source, such as ammonium phosphate dibasic, ammonium phosphate monobasic, potassium phosphate (mono-, dibasic), or sodium phosphate (mono-, dibasic), at temperatures ranging from about 20° C. to about 80° C. for about 10 sec to about 10 minutes per stage. Samples are then optionally dewatered, such as with mechanical rollers, to increase uniformity and reduce particulate formation in the immersion baths.

The samples are then air-dried at room temperature after the solution contact by immersion cycles, and then annealed at 80° C. to 160° C. for about 1 to about 20 minutes. This results in the deposition of a ceramic on the substrate, including at least one phase of calcium phosphate.

This polymer-ceramic composite is then dipped in a titanium containing solution at about 25 mM to about 500 mM of a titanium source, such as titanium chloride or titanium isopropoxide. The substrate is then removed, rinsed and dried. The polymer-ceramic composite contains titanium apatite or titanium dioxide.

This titanium apatite-containing or titanium dioxide-containing polymer-ceramic composite sample is UV absorbing as determined by UV-Vis spectroscopy and catalytic as determined by reaction and/or decomposition monitoring by FTIR or other means.

### Example 20

A lightweight (~2 oz/yd), 50D (denier) ripstop nylon and a medium weight (~4 oz/yd), 75/100D (denier) polyester (PET) twill were used as polymer substrates to deposit ceramic. The substrates were cleaned with a 2% NaOH scouring process by immersion in solution for 5 minutes, rinsed with water, and air-dried.

These substrates were then processed via batch solution contact by immersion in about 100 mM first solutions of a calcium source, calcium nitrate tetrahydrate, for about 30 seconds, and mechanically dewatered. These substrates were then immersed for about 30 seconds in about 60 mM second solutions of a phosphate source, potassium phosphate (dibasic) at temperatures of about 30° C. The samples were then dewatered, such as with mechanical rollers, to increase uniformity and reduce particulate formation in the immersion baths.

The samples were then air-dried at room temperature after the solution contact by immersion cycles until dry, and then annealed at a temperature of about 120° C. for about 10 minutes. This resulted in the deposition of a ceramic on the nylon substrate, including at least one phase of calcium phosphate. The samples were then coated according to manufacturer recommendations with two different commercially available silicone-based textile water repellent solutions and tested for tear strength according to ASTM D1424. For each sample, the tear strength was measured and determined be more than 200% of the commercially available C6 containing PFAS formulation for each substrate (Table 3) and more than 200% of the untreated substrate (Table 4). The samples also showed superior tear strength relative to the uncoated nylon polymer substrates.

TABLE 3

| | | Tear Strength |
|---|---|---|
| | | (ASTM D1424) |
| Commercial C6 | Warp | 2323 gF |
| treated nylon | Weft | 1830 gF |
| Treated nylon | Warp | 4907 gF |
| | Weft | 3837 gF |

TABLE 4

| | | Tear Strength | Breaking Strength |
|---|---|---|---|
| | | (ASTM D1424) | (ASTM D5034) |
| Uncoated nylon | Warp | 1588 gF | 82418 gF |
| | Weft | 1134 gF | 58967 gF |
| Treated nylon | Warp | 4627 gF | 86137 gF |
| | Weft | 4037 gF | 56971 gF |

### Example 21

A light weight (~2 oz/yd), 50D (denier), nylon fabric was used as the polymer substrate to deposit ceramic. The nylon substrate was cleaned with a 2% NaOH scouring process by immersion in solution for about 10 minutes, rinsed with water, mechanically dewatered, and air-dried at temperatures of about 105° C., and conditioned to laboratory conditions.

The polymer substrate was then contacted for about 30 seconds with a room temperature solution containing about 75 mM of calcium nitrate. The sample was then removed and mechanically dewatered. The sample was then contacted with a room temperature solution containing about 45 mM of potassium phosphate dibasic for about 30 seconds. The sample was removed and mechanically dewatered. The sample was air dried and annealed in an oven set at a temperature of about 140° C. for about 20 minutes.

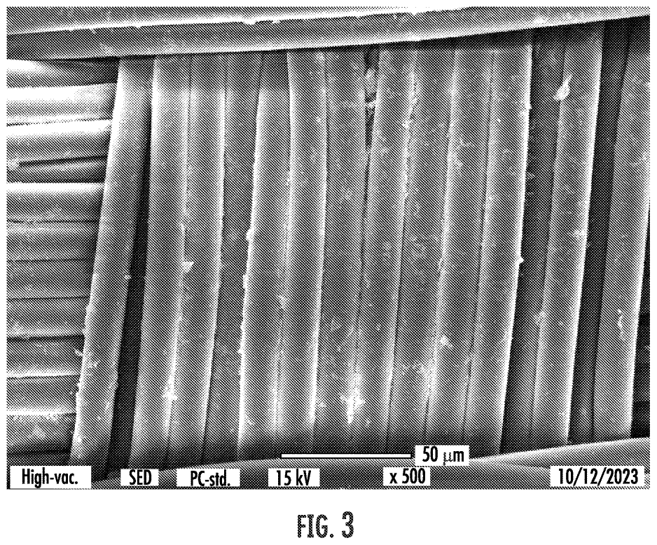

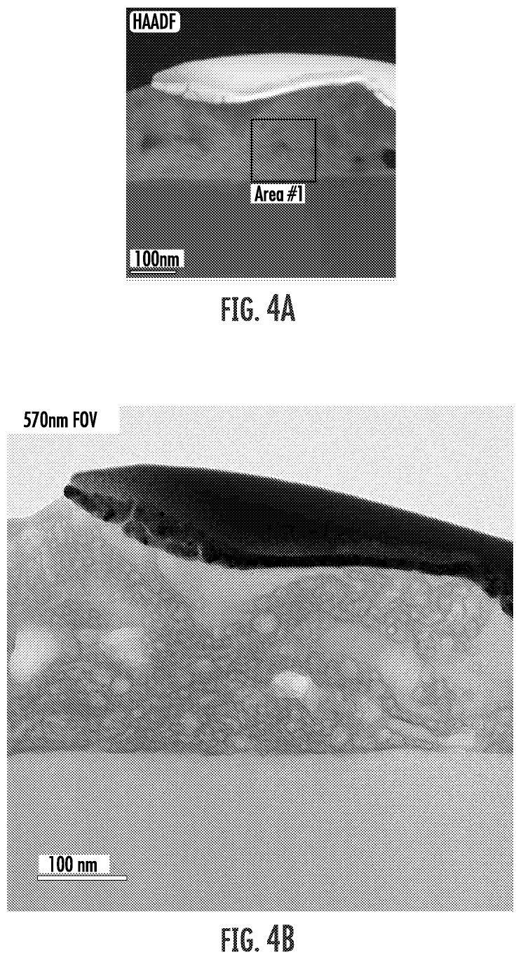

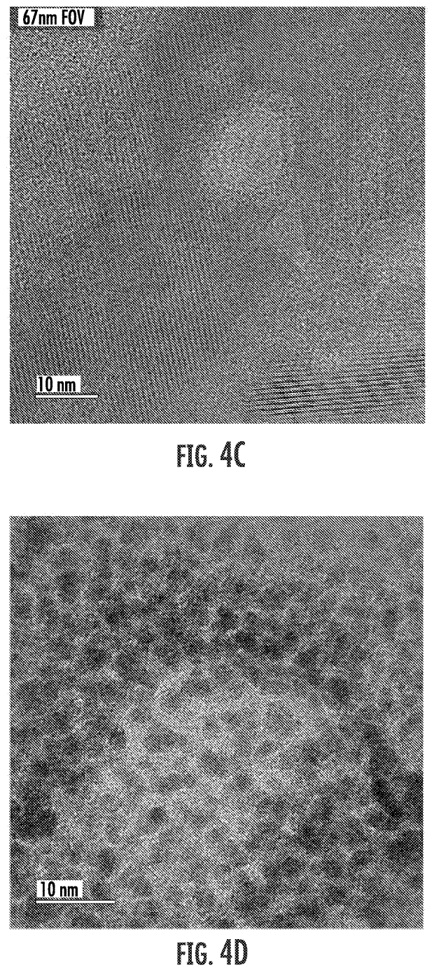

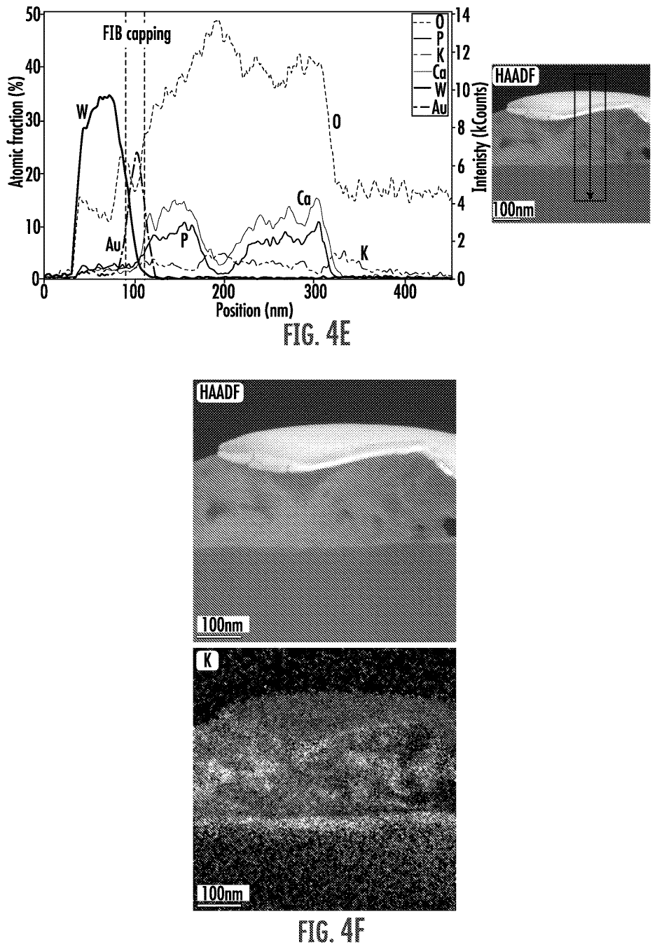

Sections of the polymer substrate were imaged by SEM-EDS, as shown in FIG. 3, and were determined to have a calcium and phosphorus containing structure with a calcium atomic percentage of 15.61+/−3.53, a phosphorus atomic percentage of 10.72+/−3.09, and calcium to phosphorus atomic percentage ratio of 1.46+/−0.53, in the section shown in FIG. 4a.

The calcium and phosphate containing structures were distributed across the sample as discrete particles, aggregates. Or agglomerations. The ceramic features appeared to be well adhered to the polymer substrate, as no loosely adhered material or regions that appear to have material previously present were observed. The deposited ceramic had a generally amorphous and unaggregated appearance, but generally consisted of low aspect ratio features. The mean characteristic sizes of the particles were estimated to be between 250 nm and 1 μm, and there were very few particles greater than 5 μm. The overall estimated size distribution range was about 0.05 μm to about 5 μm. The deposited ceramic was characterized by low dimensional aspect ratios (ratio of major to minor dimension lengths). However, the deposited ceramic particles were also not spherical or circular in nature. The average sphericity and roundness of the deposited ceramic particles are estimated from SEM analysis to be about 0.3 to about 0.9.

A section of the sample was milled away by a gallium focused ion beam to generate a small window cross section, as shown in FIG. 4b. In cross section, calcium and phosphate containing particulate and agglomerates were observed at the polymer surface with nominal thicknesses of about 20 nm to about 200 nm in thickness. Transmission electron microscopy (TEM) with selected area electron diffraction (SAED) was used to probe this region, shown in FIG. 4c and FIG. 4d. Small crystallite domains were observed within the particulate and agglomerate layer with a nominal dimension of about 5 nm and a nominal roundness of about 0.5 to about 0.9. Within these crystallite domains, nominally ordered lattice spacing was observed. Adjacent crystallites showed a similar lattice spacing, but in different angular orientations.

Crystalline domains were found in an amorphous matrix of similar elements. These domains are generally 0-dimensional, particle shaped features that could be single crystalline particles. The larger domains become more 2-dimensional. Domain sizes range from about 2 nm to about 200 nm in maximum nominal dimension. A High Resolution Tunneling Electron Microscope (HRTEM) image was collected and a Fast Fourier Transform (FFT) of the selected region of the image was conducted. The measured lattice spacings and SEM-EDS analysis of composition indicate with reasonable probability that the crystalline structures are a mixture of hydroxyapatite (HA), octacalcium phosphate (OCP), and brushite. The amorphous matrix also contains calcium and phosphorus has a similar Ca:P ratio to calcium orthophosphate. An EDS line scan from the external surface into the polymer matrix indicated a gradient of calcium within the fiber, shown in FIG. 4e.

### Example 22

A light weight (~2 oz/yd), 50D (denier), nylon fabric was used as the polymer substrate to deposit ceramic. The polyester substrate was cleaned with a 2% NaOH scouring process by immersion in solution for up about 5 minutes, rinsed with water, air-dried at a temperature of about 105° C., and conditioned to laboratory conditions. The scoured polymer substrate was divided into three sections.

The first section of the polymer substrate was then contacted for about 30 seconds with a room temperature solution containing about 25 mM calcium nitrate. The sample was then removed and mechanically dewatered. The sample was then contacted with a room temperature solution of about 15 mM of potassium phosphate dibasic for about 30 seconds. The sample was removed and mechanically dewatered. The sample was air dried and annealed in an oven set at a temperature of about 140° C. for about 10 minutes.

A second section of the polymer substrate was then contacted for about 30 seconds with a room temperature solution containing about 25 mM of calcium nitrate. The sample was then removed and mechanically dewatered. The sample was then contacted with a room temperature solution of about 15 mM of potassium phosphate for about 30 seconds. The sample was removed and mechanically dewatered. This solution contact by immersion and dewatering sequence process was repeated two additional times for a total of three cycles. The sample was air dried and annealed in an oven set at a temperature of about 140° C. for about 10 minutes.

A third section of the polymer substrate was then contacted for about 30 seconds with a room temperature solution containing about 25 mM calcium nitrate. The sample was then removed and mechanically dewatered. The sample was then contacted with a room temperature solution of about 15 mM of potassium phosphate dibasic for about 30 seconds. The sample was removed and mechanically dewatered. This solution contact by immersion and dewatering sequence process was repeated four additional times for a total of five cycles. The sample was air dried and annealed in an oven set at a temperature of about 140° C. for about 10 minutes.

Samples from each of the three sections were coated with a commercially available silicone containing textile water repellent solution including a crosslinker and a penetrant.

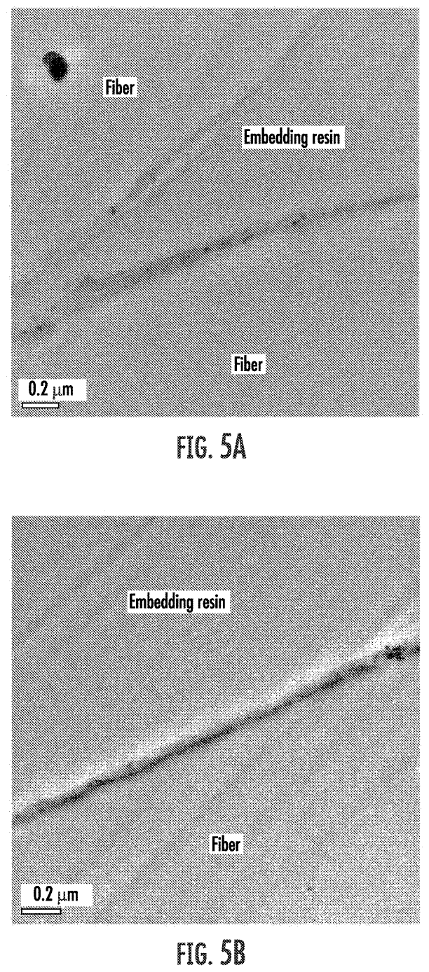

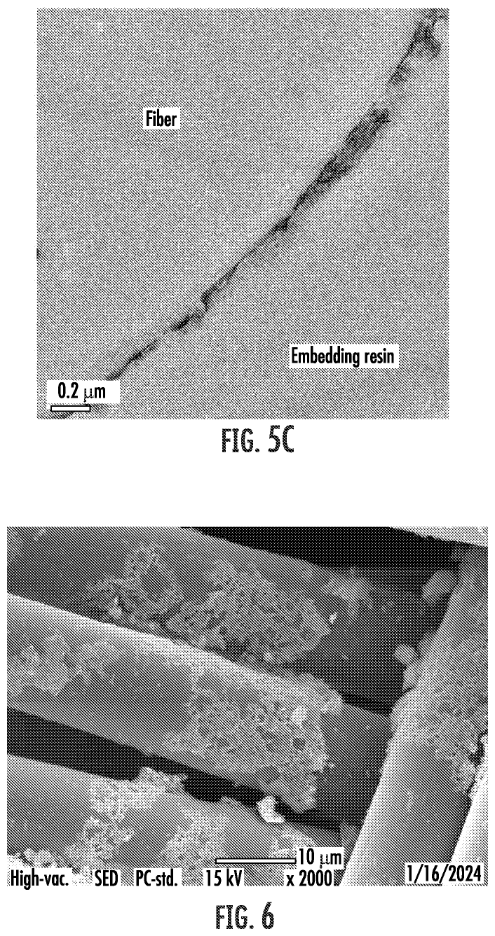

Samples from each of the sections were mounted in epoxy and investigated by TEM (FIGS. 5a-5c). The silicone coating thickness for all samples was about 50 nm to about 150 nm. In all cases, particles comprising calcium and phosphate were identified. Increasing the number of immersion cycles increased the amount and morphology of the ceramic deposits. As the number of particles increased, the particles began to transition from individual discrete particulates to an agglomerated form. Cross sections from the first sample section showed nominally round particulates with estimated roundness of 0.5 to 0.9 and nominal dimensions ranging from about 10 nm to about 50 nm. Cross sections from the second section began to show agglomerated structures and particulates ranging in nominal size of about 10 nm to about 200 nm. Some regions show a crystallinity as observed by faceted, planar, and anisotropic features. These regions appear less amorphous and show a general alignment of the major dimension parallel to a local tangent along the polymer substrate fiber external diameter. Within the larger agglomerates, nominally round (roundness of 0.5 to 1) crystalline regions appear with dimensions of about 1 nm to about 10 nm in diameter. Cross sections from the third section showed additional agglomerations and more contiguous sections with fewer independent particles. Agglomerations and particles had nominal thicknesses of about 10 nm to about 200 nm in the radial direction.

### Example 23

A light weight (~2 oz/yd), 50D (denier), nylon fabric was used as the polymer substrate to deposit ceramic. Samples (6 inches×6 inches) were quickly immersed for about 2 seconds in a calcium nitrate solution of about 75 mM and mechanically dewatered with a padder. While still wet, the samples were placed onto one of the rollers of an automatic nip roller used for dewatering. The rollers were engaged at a rate equivalent to a web speed of 10 m/min. As part of the process, the samples were immersed in a trough containing a potassium phosphate dibasic solution of about 45 mM. The entire solution contact by immersion process on the roller took about 2 seconds. The immersed were dewatered with a padder then removed from the padder and quickly transferred to a preheated oven at a temperature of about 140° C. This transfer process took about 2 seconds to about 5 seconds. Samples were dried for a period of about 2 minutes. X-ray fluorescence (XRF) data also were collected and indicated calcium (Ca) levels of about 570 ppm and phosphorous (P) levels of about 370 ppm. SEM images of these samples showed a ceramic deposit formed on the fibers with some individual particulate and some agglomerated material (FIG. 6).

### Example 24

A light weight (~1.5 oz/yd), 20D(denier), rip-stop PET polyester was used as the polymer substrate for the deposition of ceramic.

Solutions containing about 500 mM ammonium acetate, about 50 mM ammonium persulfate, and about 50 mM of either iron (II) sulfate or iron (II) acetate were prepared by mixing for about 1 hour. The pH of the solutions was measured and adjusted using either acetic acid or ammonium hydroxide to form solutions at pH of about 3, pH of about 5, pH of about 6, pH of about 7, pH of about 8, and pH of about 9. The polyester substrates were introduced to the solutions for about 10 minutes before drying at a temperature of about 140° C. for about 30 minutes. The prepared substrates were then functionalized with a perfluoroalkyl and polyfluoroalkyl substances (PFAS)-free silane based hydrophobic treatment, in a manner similar to the process described in Example 1. The substrates were evaluated for iron-based deposits by XRF. An increase of up to 200 ppm of iron on the substrates was measured for samples exposed to solutions with pH about 6 to about 9, in comparison to samples exposed to conditions of pH about 3 to pH about 5.

The samples were tested and evaluated to AATCC 22 standards for spray rating and were observed to possess water resistance by spray rating greater than 90. Durability of water repellency was measured by washing the material in a household washer for 3 wash cycles in a home washing machine. The samples were re-tested and rated to AATCC 22 standard and were observed to have spray ratings up to 70.

### Example 25

An artificial suede leather substrate was used as the polymer substrate for the deposition of ceramic. The material was a 90% PET and 10% polyurethane composite. 6 inch×6 inch samples were processed by solution contact by immersion for about 18 hours at a temperature of about 40° C. in a solution of either 100 mM or 25 mM manganese sulfate and about 170 mM ethylene glycol butyl ether. Upon removal, samples were rinsed and passed through a manual nip roller to remove excess liquid from the sample. The samples were then placed into a solution containing about 75 mM of potassium persulfate or sodium persulfate and about 1.5 M ammonia at a temperature of about 20° C. for about 90 minutes. Samples were removed, passed through a manual nip roller to remove excess liquid and dried at a temperature of about 140° C. for about 10 minutes. Samples were immersed in an alkyl silane containing solution for about 10 minutes at a temperature of about 20° C. On removal, the samples were passed through a nip roller to remove excess liquid and dried in an oven at a temperature of about 140° C. for about 10 minutes.

Samples were investigated optically for large color deviations and by a color detector that determined the difference in color value, AE, at 5 points across each sample. The higher concentration samples registered at AE of 1.5 or greater. The lower concentration samples registered a ΔE (difference in color value) about 1.4 or lower.

The water repellency of the samples was measured by AATCC 22 spray rating, scoring 85-90. The samples were also tested for wicking according to AATCC 197 and were found to have no appreciable wicking, as noted less than 1 cm, after 2 hours of exposure. The samples were also weighted and placed into a beaker filled with water at room temperature. The samples showed the presence of an air bubble surrounding the surface, preventing any wetting of the material for a period of about 2 hours.

### Example 26

A footwear open mesh shoe upper with some elasticity was used as the polymer substrate for the deposition of ceramic. The material was a blue recycled blue nylon with air permeability (ASTM D737) of about 350 cfm and moisture vapor transport of about 3000 g/day/m². 6 inch×6 inch samples were processed by immersion for about 18 h at a temperature of about 40° C. in a solution of about 25 mM manganese sulfate and about 170 mM ethylene glycol butyl ether. Upon removal, samples were rinsed and passed through a manual nip roller to remove excess liquid from the sample. The samples were then placed into a solution containing about 75 mM potassium persulfate or sodium persulfate and about 1.5 M of ammonia at a temperature of about 20° C. for about 90 minutes. Samples were removed, passed through a manual nip roller to remove excess liquid and dried at a temperature of about 140° C. for about 10 minutes. Samples were immersed in an alkyl silane containing solution for about 10 minutes at a temperature of about 20° C. On removal, the samples were passed through a nip roller to remove excess liquid and dried in an oven at a temperature of about 140° C. for about 10 minutes.

Samples were investigated optically for large color deviations and by a color detector that determined ΔE at 5 points across each sample. The samples registered at ΔE of about 1.25.

The water repellency of the samples was measured by AATCC 22 spray rating, scoring 95. The samples were also tested for wicking according to AATCC 197 and were found to have no appreciable wicking, as noted at less than 1 cm, after 2 hours of exposure. The samples were also weighted and placed into a beaker filled with water at room temperature. The samples showed the presence of an air bubble surrounding the surface, preventing any wetting of the material for a period of about 2 hours.

### Example 27

A lightweight (~2 oz/yd), 50D (denier), rip-stop nylon was used as polymer substrates for the deposition of ceramic. Samples were immersed into a first solution, removed and dried at 140° C. for about 10 min, immersed into a second solution, removed and rinsed twice in deionized (DI) water, and dried at a temperature of about 140° C. for about 10 minutes.

First solutions contained about 400 mM Mn(SO₄) and about 170 mM ethylene glycol butyl ether (EGBE). Samples were immersed into the first solutions at a temperature of about 40° C. for about 72 hrs. Each solution contact by immersion took place in 50 mL vials on a shaker table set to about 75 rpm. Samples were removed and dried at a temperature of about 140° C. for about 10 minutes.

Each of the samples was then contacted with a second solution at a temperature of about 25° C. for about 1.5 hrs. The second solutions contained about 75 mM of K₂S₂O₈ and about 1453 mM, or about 750 mM, or about 150 mM, or about 15 mM, or no NH₃. Additional second solutions containing about 750 mM, about 150 mM, about 15 mM, or no NH₃ were prepared and dosed with KOH to bring the solution to a pH of about 13.5. Samples were removed, rinsed twice with DI (Type II) water, and dried at a temperature of about 140° C. for about 10 minutes.

The samples were imaged by SEM. The samples with second solution exposure greater than 150 mM NH₃ exhibited a contiguous interconnected platelike, nanostructured layer and some larger discrete particulates, and some cracking of the contiguous structure was observed. The nanostructured layers had a thickness of less than about 0.2 μm. The sample of 15 mM NH₃ showed some discrete particle like structures with dimensions less than 1 μm in size. No structures were observed in the no NH₃ exposure. The samples with second solution exposure greater than 150 mM of NH₃ and KOH showed a contiguous interconnected platelike, nanostructured layer and some larger discrete particulates, and some cracking of the contiguous structure was observed. The nanostructured layers had a thickness of less than about 0.2 μm. The sample of both 15 mM NH₃ and no NH₃ with KOH added showed discrete particle like structures with dimensions less than 1 μm in size. EDS analysis indicated the structures contained Mn.

### Example 28

Three different materials were used as polymer substrates for the deposition of ceramic, a lightweight (~2 oz/yd), 50D (denier), rip-stop nylon, a light weight (~1.5 oz/yd), 20D(denier), rip-stop PET polyester, and a medium weight (~4 oz/yd), 75/100D (denier) polyester (PET) twill. Samples of each fabric were cleaned using an isopropyl alcohol solution and dried at a temperature of 105° C. for about 10 minutes. Samples were then immersed into a reaction mixture, removed, and dried.

The reaction mixture was prepared by adding about 20 mL of about 10% TiCl₃ to about 15% TiCl₃ (in HCl) to about 90 mL of DI water while stirring. A second mixture was generated by combining about 10% NH₃ and about 1% H₂O₂ in water. While stirring the initial solution, the second mixture was added dropwise to the initial solution until a desired pH was reached, resulting in four (4) reaction mixtures at pH of about 3, about 4.5, about 6, and about 7.5.

One sample of each fabric was suspended into each of the reaction mixtures for about 18 hrs. On removal, each of the fabric samples was rinsed by repeated dipping in DI water until no more particulate or holdup was visibly removed. The samples were then dried in a forced convection oven at a temperature of about 140° C. for about 2 min.

The samples were imaged by SEM and exhibited highly textured structure formation on all samples. XRF was used to investigate the titanium concentration, [Ti], on the samples. Each of the fabrics showed a maximum [Ti] at the pH setpoint of 4.5. The amount of deposited material correlated with the wet pickup of the initial fabric. The greater wet pickup fabrics showed a nearly contiguous shell-like structure with a thickness of less than about 0.5 m.

### Example 29

A lightweight nylon rip-stop fabric of about 64 g/m² was used as the polymer substrate for the deposition of ceramic. A first solution was prepared consisting of 50 mM calcium nitrate tetrahydrate and 50 mM of titanium oxysulfate (TiO(SO₄). A second solution was prepared consisting of 60 mM potassium phosphate dibasic. A first set of samples (6 inches×6 inches) were immersed for about 30 seconds in the first solution at a temperature of about 25° C. and mechanically dewatered using a padder. The samples were then immersed into the second solution for about 30 seconds at a temperature of about 25° C. and mechanically dewatered using a padder. The immersed and dewatered samples were then removed from the padder and quickly transferred to a preheated oven at a temperature of about 140° C. and dried for about 20 minutes.

A second set of samples was immersed into the first solution, dewatered, and immersed into the second solution and dewatered. This cycle was completed three times prior to the drying step.

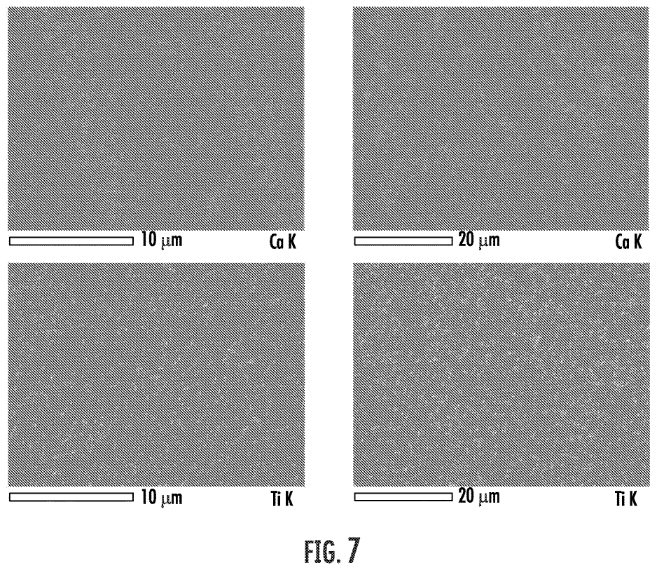

SEM images of these samples showed a ceramic deposit formed on the fibers with some individual particulate and some agglomerated material. The first samples showed particles and agglomerated material with nominal dimensions of about 2 μm. The second set of samples showed particles and agglomerated material with nominal dimensions of about 5 μm. EDS analysis of all of the samples detected Ca and Ti signals uniformly distributed (FIG. 7). The second set of samples from the three cycle processing show increased signal strength and a greater amount of agglomeration as defined by clumping of signals.

### Example 30

A cellulose based polymer matrix was used as substrate for the deposition of ceramic. The 8″×8″ samples with initial weight of about 255 g/m² were used as the substrates.

The polymer samples were immersed for about 30 minutes in an aqueous bath held at a temperature of about 20° C. containing 50 mM of ammonium acetate, 500 mM of manganese(II) acetate, 4350 mM of acetic acid, and 50 mM of ammonium persulfate. The immersed samples were then transferred to a deionized water bath and immersed for 30 seconds. The samples were then removed from the solution and dried at a temperature of about 105° C. for about 10 minutes. The samples were then immersed for 18 hours in an ethanol bath containing about 1% alkyl silane. The samples were removed from the solution and annealed at 105° C. for 60 minutes.

A dense nanostructured shell of manganese hydroxide was observed on the surface of the cellulose matrix when imaged by SEM. The composition of the coating was confirmed with energy dispersive x-ray spectroscopy (EDS) and the coating was found to contain a mixture of manganese and oxygen on top of the mostly carbon-containing polymer surface. The samples were analyzed for water contact angle after lab conditioning and tape adhesion via sessile drop. The substrates exhibited a water contact angle of about 1450 before and after tape adhesion and removal.

### Example 31

A cellulose based polymer matrix was used as substrate for the deposition of ceramic. The 8″×8″ samples with initial weight of about 255 g/m² were used as the substrates.

The polymer samples were immersed in two different alternating aqueous solutions to deposit an interconnected, platelike ceramic structure on the substrate. The procedure for each sample was to immerse the samples in solution (a) for about 30 seconds, remove and allow the sample to drain in air for about 10 seconds, then to immerse the sample in solution (b) for about 30 seconds, remove and allow the sample to drain in air for about 10 seconds. This immersion and drying sequence was repeated 3 times for each sample. The conditions of the (a) and (b) solutions are noted in Table 5.

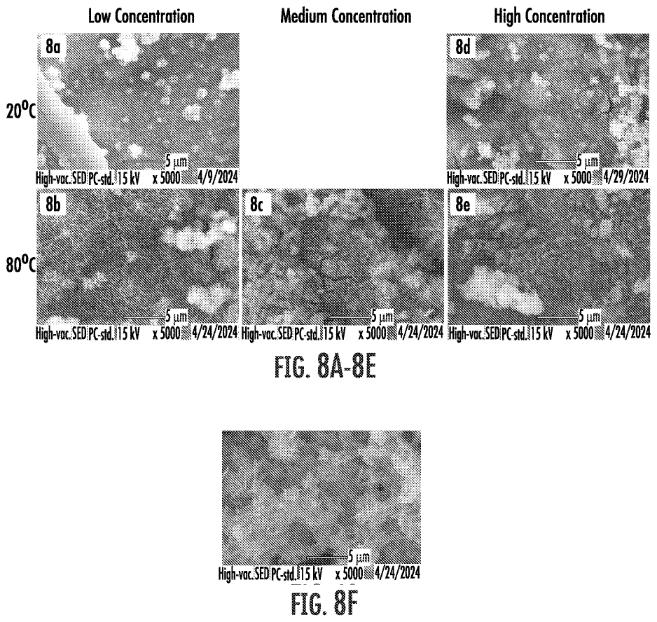

TABLE 5

| | | | Medium | | |
|---|---|---|---|---|---|
| | | | Concen- | | |
| | Low Concentration | | tration | High Concentration | |
| Immersion | RT, about | 80° C. | 80° C. | RT, about | 80° C. |
| bath | 20° C. | | | 20° C. | |
| temperatures | | | | | |
| Bath (a) | 25 mmol | | 100 mmol | 400 mmol | |
| concentration | | | | | |
| Bath (b) | 15 mmol | | 60 mmol | 240 mmol | |
| concentration | | | | | |
| Example | FIG. 8a | FIG. 8b | FIG. 8c | FIG. 8d | FIG. 8e |
| Image | | | | | (after tape |
| | | | | | adhesion) |

| | |
|---|---|
| Curing | 140° C. for 10 minutes |

The aqueous bath (a) contained calcium nitrate tetrahydrate and (b) contained potassium phosphate dibasic at the concentrations indicated in Table 5.

A dense nanostructured interconnected layer of calcium phosphate was observed on the surface of the cellulose matrix when imaged by SEM. The composition of the coating was confirmed with energy dispersive x-ray spectroscopy (EDS) and the coating was found to contain a mixture of calcium and phosphorous on top of the mostly carbon-containing polymer surface. The samples were analyzed for water contact angle after lab conditioning and tape adhesion via sessile drop. The substrates exhibited a water contact angle of about 145° before and after tape adhesion and removal. The conditions corresponding to FIG. 8e created a very thick coating which resulted in a large flakelike coating on the paper substrate.

### Example 32

A cellulose based polymer matrix was used as substrate for the deposition of ceramic. The 8″×8″ samples with initial weight of about 255 g/m2 were used as the substrates. The sample generated that corresponded to the conditions of Example 31, FIG. 8e, was placed into contact with a 200 μm thick conductive polycarbonate tape with a 30 μm thick carbon filled acrylic adhesive on both sides.

SEM images were taken of the adhesive tape after adhesion to the polymer-ceramic composite. The adhesion was achieved by placing the coated sample in contact with the tape for about 20 seconds under light pressure by a gloved hand. FIG. 8f shows the interconnected ceramic structure that was transferred to the tape. FIG. 8e shows the interconnected ceramic structure remaining on the polymer substrate. These images indicate strong adhesion by the ceramic to the substrate and to the adhesive.

Although the foregoing invention has been described in some detail by way of illustration and examples for purposes of clarity of understanding, it will be apparent to those skilled in the art that certain changes and modifications may be practiced without departing from the spirit and scope of the invention, which is delineated in the appended claims. Therefore, the description should not be construed as limiting the scope of the invention.

All publications, patents, and patent applications cited herein are hereby incorporated by reference in their entireties for all purposes and to the same extent as if each individual publication, patent, or patent application were specifically and individually indicated to be so incorporated by reference.

1.-32. (canceled)

33. A polymer-ceramic composite, comprising: a polymer substrate and a ceramic, wherein the polymer substrate has an external surface and a polymer matrix internal volume, a first portion of the ceramic is on the external surface, and a second portion of the ceramic occupies at least a portion of the polymer matrix internal volume.

34. The polymer-ceramic composite according to claim 33, wherein said polymer-ceramic composite is a fiber, a laminate, a film, a textile material, a paper, or a combination thereof.

35.-39. (canceled)

40. The polymer-ceramic composite according to claim 33, wherein said polymer substrate comprises: a polyester, a polyamide, a polyolefin, a substituted polyolefin, a polyurethane, a polyol, a vinyl polymer, an acrylate polymer, a polycarbonate, a polyether, cotton, wool, paper, a cellulosic material, or a combination thereof, polyethylene terephthalate (PET), a nylon, polyethylene, polypropylene, polyvinyl chloride (PVC), polyvinyl alcohol (PVOH), polyvinyl acetate (PVAc), polyvinylpyrrolidone, polyethylene glycol (PEG), polymethylmethacrylate (PMMA), cellulose, or a mixture thereof; a hydrocolloid; locust bean gum, starch, carrageenan, pectin, chitosan, xanthan gum, cellulose, carboxymethyl cellulose, or a mixture thereof; or wool, cotton, hemp, animal hair, collagen, keratin, silk, chitin, flax, jute, or a mixture thereof.

41.-46. (canceled)

47. The polymer-ceramic composite according to claim 33, wherein the first portion of the ceramic is less than about 1 μm or less than about 100 nm in thickness.

48. The polymer-ceramic composite according to claim 33, wherein the ceramic layer is nanostructured.

49. The polymer-ceramic composite according to claim 33, wherein the second portion of the ceramic penetrates more than about 10 nanometers from the external surface into the polymer matrix internal volume.

50. The polymer-ceramic composite according to claim 33, wherein the polymer matrix comprises a hydraulic diameter, and wherein the second portion of the ceramic penetrates less than about 90% of the hydraulic diameter, from the external surface of the polymer substrate into the polymer matrix internal volume.

51. The polymer-ceramic composite according to claim 33, wherein the ceramic comprises a metal, and wherein the atomic mole percentage of the metal of the second portion of the ceramic decreases when measured from the external surface of the polymer substrate into the polymer matrix internal volume.

52. The polymer-ceramic composite according to claim 51, wherein the atomic mole percentage of the metal decreases at a decreasing rate from the external surface of the polymer substrate into the polymer matrix internal volume.

53.-57. (canceled)

58. The polymer-ceramic composite according to claim 33, wherein the polymer matrix internal volume comprises both convex and concave Gaussian geometric features, wherein the ceramic comprises a metal, and wherein the atomic mole percentage of the metal in the convex features is equal to or greater than the atomic mole percentage of the metal in the concave features.

59.-66. (canceled)

67. The polymer-ceramic composite according to claim 33, further comprising a functional molecule, wherein at least a portion of the functional molecule occupies the polymer matrix internal volume.

68. The polymer-ceramic composite according to claim 67, wherein the functional molecule penetrates more than about 10 nanometers into the polymer matrix internal volume.

69.-70. (canceled)

71. The polymer-ceramic composite according to claim 6,
wherein the functional molecule penetrates a shorter distance into the polymer matrix internal volume in comparison to an identical polymer substrate that does not comprise the ceramic.

72. The polymer-ceramic composite according to claim 6, wherein the functional molecule diffusion coefficient in the polymer matrix internal volume is greater than about 5% less than the diffusion coefficient of the functional molecule in an identical polymer substrate that does not comprise the ceramic.

73.-78. (canceled)

79. The polymer-ceramic composite according to claim 33, wherein said ceramic comprises a rare earth metal, a transition metal, an alkali metal, an alkaline earth metal, or a combination thereof.

80. The polymer-ceramic composite according to claim 79, wherein the ceramic comprises calcium,-manganese, phosphorous, iron, nickel, magnesium, titanium, lithium, copper, or zinc.

81. The polymer-ceramic composite according to claim 79, wherein said ceramic comprises an oxide, a hydroxide, a phosphate, a layered double hydroxide, a sulfate, a carbonate, or an oxalate of the rare earth metal, the transition metal, the alkali metal, or the alkaline earth metal, or a combination thereof.

82. The polymer-ceramic composite according to claim 81, wherein said ceramic comprises manganese oxide, iron oxide, calcium carbonate, hydroxyapatite, calcium phosphate, calcium oxalate, magnesium carbonate, calcium sulfate, magnesium sulfate, or a combination thereof.

83. A method of manufacturing a polymer-ceramic composite according to claim 33, comprising
(a) contacting a polymer substrate with at least one solution comprising a metal salt or a metal-organic complex, and, optionally, an oxidizing agent, an amine, ammonia, a penetrant, a surfactant, a release agent, or other reactive precursor, or a combination thereof, wherein said solution is at least partially absorbed into the polymer matrix;
(b) heating or otherwise ensuring a temperature of the polymer substrate produced in step (a) to a temperature sufficient to remove the solvent from said polymer substrate, sufficient to drive a ceramic-forming reaction with one or more of the metal salt(s), or sufficient to decompose or react the metal-organic complex, thereby forming a polymer-ceramic composite; and
(c) optionally, coating said polymer-ceramic composite produced in step (b) with one or more functional layer(s) or molecules.

84.-96. (canceled)

97. An assembly comprising polymer-ceramic composites according to claim 33, wherein at least a portion of the polymer-ceramic composites are in the form of fibers.
